(19) United States
(12) Patent Application Publication
(10) Pub. No.: US 2004/0047588 A1
(43) Pub. Date: Mar. 11, 2004

(54) Package medium, reproduction apparatus, and reproduction method

(76) Inventors: Tomoyuki Okada, Nara-shi (JP); Kazuhiko Nakamura, Hirakata-shi (JP); Yasushi Uesaka, Sanda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/397,313

(22) Filed: Mar. 27, 2003

(30) Foreign Application Priority Data
Mar. 27, 2002 (JP) 2002-088472

(51) Int. Cl. H04N 5/781

(52) U.S. Cl. 386/46; 386/125

(57) ABSTRACT

A package medium stores a plurality of video objects and management information relating to the video objects. The management information includes playback list information and event handlers activated by events including at least user operations. A unique identifier is assigned to each event handler.

### BACKGROUND OF THE INVENTION

1. Field of the Invention

The present invention relates generally to a recording method for a package medium used to record movies and other digital video content, and to a reproduction method and reproduction apparatus for this package medium. The invention relates more specifically to HD-DVD (high definition or high density digital video disc) media, the next generation of DVD (digital video disc) media and technology, for which a substantial market and industry already exists.

2. Description of Related Art

Standard density DVD media (referred to herein as SD-DVD or simply DVD media) are described below according to the prior art.

FIG. 45 shows the logical structure of an SD-DVD disc. As shown in the bottom row in FIG. 45, a logical address space is located between the lead-in and lead-out areas of a DVD disc, and a file system is written at the beginning of this logical address space.

The file system, such as described in ISO 9660 and the UDF (Universal Disc Format) specifications, represents data on the disc as directories and files, and is designed to improve usability. File systems such as FAT and NTFS are similarly used everyday on personal computers to present files and file directories on the computer screen so that the user can easily read and write data.

SD-DVD media use a combination of both the UDF and ISO 9660 file systems known as UDF Bridge. UDF Bridge enables reading data using either a UDF or ISO 9660 file system driver. It should be noted that DVD media referred to here are ROM discs for package media and writing is physically not possible.

Data recorded to DVD can be viewed on a computer through the UDF Bridge as a listing of directories and files as shown in the upper left part of FIG. 45. DVD application data is stored in the “VIDEO_TS” directory located directly below the root directory (“ROOT” in the figure). Application data is recorded as a number of files particularly including the following.

VIDEO_TS.IFO: video transport stream information file containing disc playback control information

VTS_{—}01_{—}0.IFO: playback control information file for video title set (VTS) #1

VTS_{—}01_O.VOB: video title set #1 stream file (video object)

There are two file name extensions: “IFO” denoting files containing playback control information, and “VOB” denoting files containing an MPEG stream (AV data). The playback control information includes information for implementing the interactive features enabled with DVD content (more specifically, a technology enabling playback to change dynamically (such as with different story lines) according to input from the user), title information such as meta-data, and other information added to the AV stream. This playback control information is also called navigation information.

The playback control information files in the example shown in FIG. 45 are “VIDEO_TS.IFO” relating to overall disc management, and “VTS_{—}01_{—}0.IFO” containing playback control information for each video title set on the disc. It should be noted that multiple titles, which could be different movies or different versions of the same movie, can be stored to a single DVD disc. The number such as “01” in the title name denotes the number of the video title set. Playback control information for video title set #2 is therefore written as “VTS_{—}02_{—}0.IFO”, for example.

The DVD navigation space in the DVD application layer is shown in the upper right part of FIG. 45. This DVD navigation space is the logical structure space described by the playback control information. The information in “VIDEO_TS.IFO” expands into the DVD navigation space as the VMGI (Video Manager Information) file. The information in “VTS_{—}01_{—}0.IFO”, that is, the playback control information present in each video title set, expands into the DVD navigation space as VTSI (Video Title Set Information).

Program Chain Information (PGCI) containing information about the playback sequence called a Program Chain (PGC) is written in the VTSI. The PGCI is composed of a group of some or all video objects (abbreviated VOB and indicating an MPEG stream) called “cells” in a specific address range, and commands as a type of programming information.

Commands are processed by a virtual machine defined by the DVD standard, and are similar to Java® scripts that can be executed by a browser. However, whereas Java® scripts perform logic operations and can be used for window and browser control (such as to control opening a new browser window), DVD commands perform logic operations and enable playback control of AV titles (such as controlling which chapter is reproduced).

Each cell contains the start and end addresses (logical addresses) of a VOB recorded on the disc. The player reads and reproduces data using the VOB start and end address information written to the cell. The player reads and reproduces data from the disc using the VOB start and end address information recorded in the cells.

FIG. 46 is a schematic diagram describing the navigation information embedded in an AV stream. Interactive operation, an important feature of SD-DVD media, is not achieved by using only the navigation information recorded to the “VIDEO_TS.IFO” and “VTS_{—}01_{—}0.IFO” files described above. Important information for achieving interactive operation is multiplexed to the video and audio data in the AV stream using a dedicated carrier called navigation packs (navi-pack or NV_PCK).

A menu providing a number of user-selectable choices is described next as an example of simple interactive operation. A menu may present a number of buttons. Clicking a particular button or selecting a particular menu item causes a specific process to run. One button is selected in this example (a semi-transparent overlay covers the selected button as indicated by highlighting). Using directional cursor keys (typically up, down, right, left arrows) on a remote control device, the user moves the selected button indicated by highlighting to the desired selection. After using these directional cursor keys to select and highlight the desired button, the user operates a button (pushing an execution key) to execute the selection. This causes the process associated with that button to run, generally causing the corresponding title or chapter to play.

The upper left part of FIG. 46 shows the content of NV_PCK. NV_PCK includes the highlight color and other information for each button. Color pallet information is written to the highlight color information to specify the semi-transparent highlight, color used for the overlay display. The button information includes the rectangular area denoting the location of each button, navigation information defining which other button is selected from the current button when the user operates one of the cursor keys, and button command information (the command that is run when a particular button is operated).

As shown in the upper right part of the middle of FIG. 46 the menu highlights are generated as overlay images. Overlay images are images that add the color specified by the color pallet in the area specified by the button area definition in the button information. The overlay image is merged with the background image shown on the right in FIG. 46 for display on the screen.

Menus can thus be presented with DVD media. The reason for embedding part of the navigation data in the stream using NV_PCK is so that applications updating dynamic menu information synchronized to the stream, such as presenting a special menu for five to ten minutes during video playback, can be achieved.

The only way DVD content can be viewed conventionally is by connecting a DVD player to a television and viewing the content on the television. Advances in information technology, however, have made it possible to watch movies on a personal computer and connect DVD players to the Internet, thus breaking down the conventional concept of DVD players being AV products and personal computers not being AV products. It is therefore expected that new ways of enjoying multimedia content, such as linking AV content recorded to DVD with the Internet, will continue to emerge in the coming years.

What becomes a problem in this case is that, as shown in FIG. 46, information enabling interactive operation and particularly menus is embedded in the stream using the NV_PCK on SD-DVD media.

Navigation data embedded in the stream can only be extracted by analyzing the stream. The navigation data can be easily read and analyzed insofar as it is recorded to a special file such as “VIDEO_TS.IFO”, but it is difficult to read navigation data embedded in the stream. Navigation data occupies from only a few hundred kilobytes to several megabytes while the stream data accounts for more than 4 GB of the 4.7 GB capacity of SD-DVD media. Finding the necessary navigation data in a 4 GB data stream obviously requires reading the stream from the beginning, and anywhere from several minutes to several dozen minutes may be required to interpret the stream. Such performance is unacceptable for most practical purposes.

This is not particularly a problem during simple normal playback because the required navigation data can be acquired at the required timing. It is a problem when the navigation data uses links to HTML (Hyper Text Markup Language: a language used in the Internet) content such as increasingly used on DVD media.

This problem is described with reference to FIGS. 47 and 48. FIG. 47 shows an example of a multipage menu such as often used with DVD. A multipage menu is used, for example, for a chapter menu enabling selecting different chapters when there are multiple selectable chapters and not all chapters (i.e. buttons) can be displayed on a single screen. It is not uncommon to have twenty to thirty chapters set in a single movie title, and multipage chapter menus are therefore often used.

In addition to selectable chapters, a multipage menu also has buttons for navigating between the menu pages. The example shown in FIG. 47 shows a chapter menu with three pages. PGC #1 for the left page displays “CHAPTER 1”, “CHAPTER 22”, and “NEXT PAGE”. If the user selects “CHAPTER 1” or “CHAPTER 22”, the command corresponding to the operated button is activated and playback of the PGC (Program Chain) or cell corresponding to that chapter begins. If the user operates the “NEXT PAGE” button, the PGC for the next page, which is PGC #2 in this example, is reproduced.

PGC #2 for the middle page in FIG. 47 presents buttons for “CHAPTER 3”, “CHAPTER 4”, “NEXT PAGE” and “PREVIOUS PAGE” on the menu screen. When “CHAPTER 3” or “CHAPTER 4” is selected the corresponding PGC or cell is reproduced as above. If “NEXT PAGE” is selected PGC #3 corresponding to the next page is reproduced, and if PREVIOUS PAGE is selected PGC #1 for the previous page is reproduced. ThG same basic operation applies to PGC #3 shown as the third page on the right side in FIG. 47.

As described above, a multipage menu is implemented by storing each page as a separate PGC and moving between pages, i.e., PGC, by means of commands associated with buttons on each page. In other words, the player reads and displays the menu to be presented next when the user operates a particular button (command). The player does not know what is to happen after the next button is selected, therefore simply sequentially executes the selected commands, and does not know the internal structure of the multipage menu.

FIG. 48 is an example of an application merging HTML content with a DVD. A personal computer is significantly better at displaying text information than a television, and can display AV content together with other content using a browser or other application. One example of these personal computer capabilities is the ability to display a menu divided between multiple pages on a DVD as a single menu using a browser on a computer. FIG. 48 shows the multipage menu comprising three pages shown in FIG. 47 presented on a single screen.

The player must, however, read the stream to determine how many pages are in a menu and what processes run when each button is selected. This example uses a multipage menu of only three pages, but when the number of pages in the multipage menu is large or, in an extreme example, when the data streams are recorded at disparate locations at the inside and outside circumferences of the disc, seek operations become necessary and gathering the information needed to generate the browser window becomes time consuming.

Additionally, the menu screens are generated by drawing buttons over a background image and applying highlighting using an overlaid transparent color to the selected button. The menus therefore have little visual appear (visual refinement) and are significantly visually inferior compared with common PC-based interactive media.

Further, because the button information embedded in the screen cannot be removed even if it is linked to HTML-like content, a single, rich menu can be presented with an HTML screen but visually inferior menus are sequentially presented with the DVD screen. This is undesirable both for writing the application and for the visual design of the user interface.

Furthermore, embedding the navigation data in the AV stream limits the amount of AV data that can be carried in the AV stream.

An object of the present invention is therefore to solve the aforementioned problems by providing technology for achieving a new package medium (HD-DVD) merging AV content and computers.

The more specific object of our invention is to solve the following problems.

(1) When views that differ from the view provided with normal AV playback, such as playback using HTML links, are implemented by means of interactive data embedded in the stream, the interactive scenarios cannot be read in advance.

(2) A menu display function that overlays a semi-transparent highlight color to buttons in the menu is visually inferior to interfaces that can be presented by a personal computer.

### SUMMARY OF THE INVENTION

A first aspect of the present invention provides a package medium for storing video objects and management information relating to the video objects for playback by a data reproduction apparatus, wherein the management information includes playback list information and a plurality of event handlers activated by events including at least user operations, an identifier being assigned to each event handler, and wherein the playback list information includes cell information containing information specifying a playback section of a video object and the identifier of the event handler valid while each playback section is being reproduced, and playback sequence information indicating the playback sequence of the playback sections specified by the cell information.

With this first aspect of the invention management information for managing the events activated during video object playback is stored separately from the video objects in the package medium, enabling implementing a variety of interactive scenarios. Further, because the management information is not embedded in the video objects, the reproduction apparatus can know the management information relating to a video object without analyzing the video object. Furthermore, the amount of video data and audio data that can be recorded to a video object is therefore also not limited.

The cell information is allowed to indicate a part or all of the video object.

Further, it is preferable that the playback list information includes a plurality of pieces of cell information, and that each of two different pieces of cell information is allowed to specify a part or all of a same video object.

Furthermore, it is preferable that the management information includes an event handler that is enabled while the package medium is being reproduced by a reproduction apparatus.

A second aspect of the present invention provides a reproduction apparatus for reproducing a package medium storing video objects and management information relating to the video objects, wherein the management information includes playback list information and a plurality of event handlers activated by events including at least user operations, an identifier being assigned to each event handler, wherein the playback list information includes cell information containing information specifying a playback section of a video object and an identifier of an event handler valid when each playback section is being reproduced, and playback sequence information indicating the playback sequence of the playback sections specified by the cell information, and wherein the reproduction apparatus includes: a management information processing unit for extracting cell information and playback sequence information contained in the playback list information from the management information, receiving an event, and activating the event handler to which the corresponding identifier is assigned; and a video object processing unit for reproduction the video object based on the cell information and playback sequence information extracted by the management information processing unit.

A third aspect of the present invention provides a reproduction method for reproduction a package medium storing video objects and management information relating to the video objects, wherein the management information includes playback list information and a plurality of event handlers activated by events including at least user operations, an identifier being assigned to each event handler, wherein the playback list information includes a plurality of pieces of cell information containing information specifying a playback section of a video object and an identifier of an event handler valid while each playback section is being reproduced, and playback sequence information indicating the playback sequence of the playback sections specified by the cell information, and wherein the reproduction method comprises: extracting cell information and playback sequence information contained in the playback list information from the management information; reproduction a video object based on the cell information and playback sequence information; and activating the event handler to which the identifier corresponding to the event is assigned at a detection of the event.

### BRIEF DESCRIPTION OF THE DRAWINGS

Other objects and features of the present invention will be understood from the following description on preferred embodiments of the invention with reference to the accompanying drawings.

FIG. 1 is a schematic diagram of an HD-DVD system;

FIG. 2 is a schematic diagram of a media player;

FIG. 3 shows the program and cell structure;

FIG. 4 is a model state transition diagram;

FIG. 5 shows the title and chapter structure;

FIG. 6 describes the menu structure;

FIG. 7A shows an example of a preprocess and FIG. 7B shows an example of a host process;

FIG. 8 describes the relationship between preprocess, post-process, and event handlers;

FIG. 9 describes the state transitions and preprocess and post-process validity;

FIG. 10 describes button operation;

FIG. 11 describes the relationship between images and streams;

FIG. 12 describes the relationship between images and scripts;

FIG. 13 describes a particular menu implementation;

FIG. 14 describes the structure of a parental lock feature;

FIG. 15 describes the time map structure;

FIG. 16 describes accessing the stream from a cell through the time map;

FIG. 17 describes a seamless branch application;

FIG. 18 describes the structure of interleaved blocks;

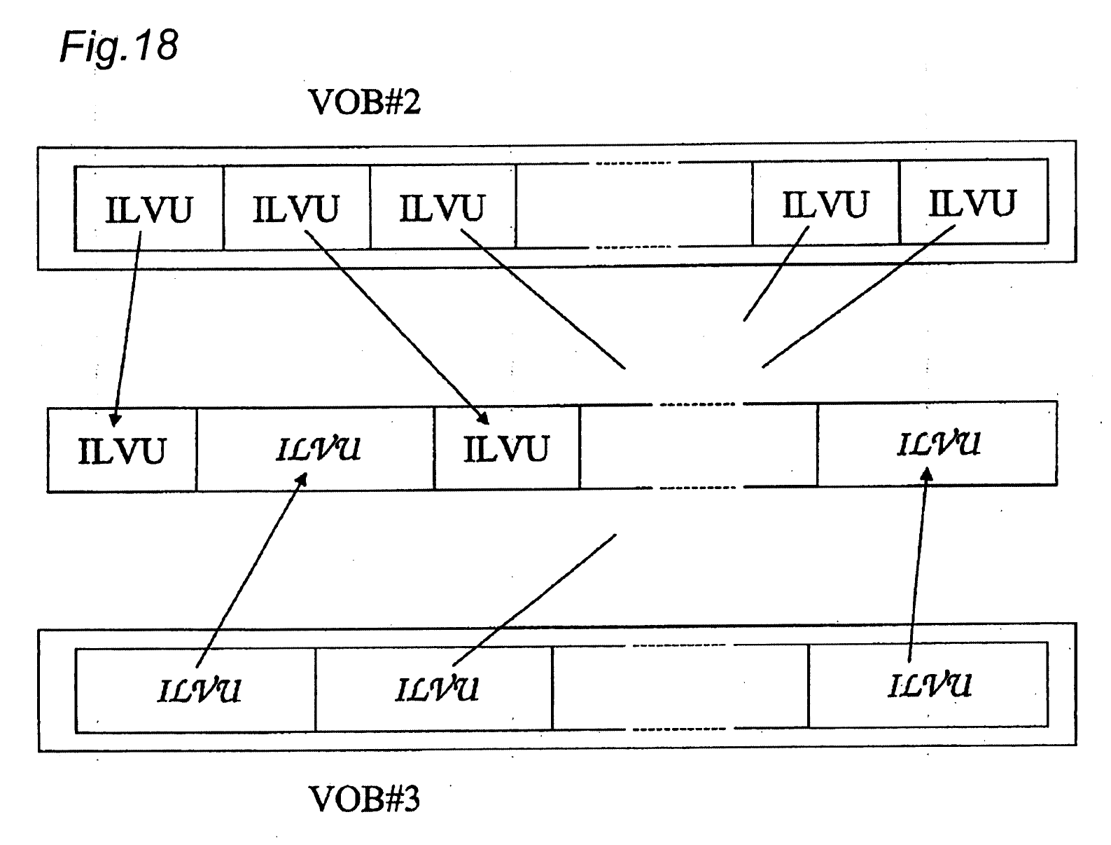

FIG. 19 describes a jump model using a track buffer;

FIG. 20 describes system variables;

FIG. 21 describes a UOP Group;

FIG. 22 describes the directory and file structure of an HD-DVD disc;

FIG. 23 describes the data structure concept;

FIG. 24 describes an example of volume information;

FIG. 25 describes an example of program information;

FIG. 26 describes an example of cell information;

FIG. 27 describes an example of cell information;

FIG. 28 describes an example of menu information;

FIG. 29 describes an example of event handler information;

FIG. 30 describes an example of stream information;

FIG. 31 describes an example of stream information;

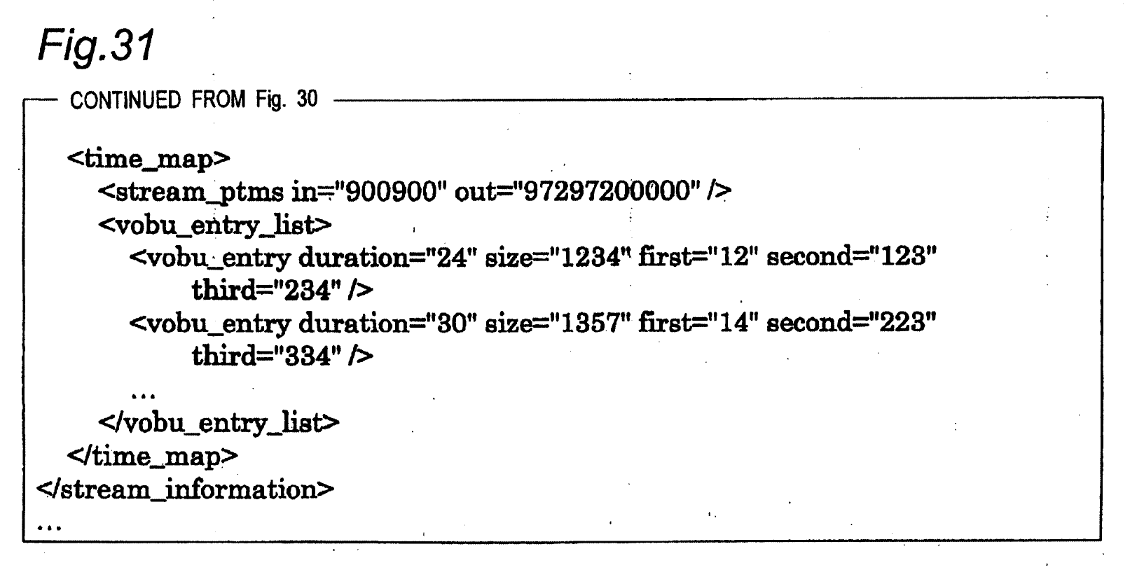

FIG. 32 is a flow chart of operation after disc insertion;

FIG. 33 is a flow chart of program playback;

FIG. 34 is a flow chart of a UOP process;

FIG. 35A is a flow chart of a preprocess and FIG. 35B is a flow chart of a post-process;

FIG. 36 describes an exemplary title menu implementation;

FIG. 37 describes an exemplary chapter menu implementation;

FIG. 38 describes an exemplary implementation of a multilingual title menu;

FIG. 39 describes an exemplary implementation of a multipage chapter menu;

FIG. 40 describes an exemplary audio selection menu;

FIG. 41 describes an exemplary implementation of a multilingual menu using images;

FIG. 42 describes the link between HD-DVD media and external applications;

FIG. 43 describes the link to an external application in an HD-DVD player;

FIG. 44 describes menu information for access control;

FIG. 45 describes the structure of SD-DVD media;

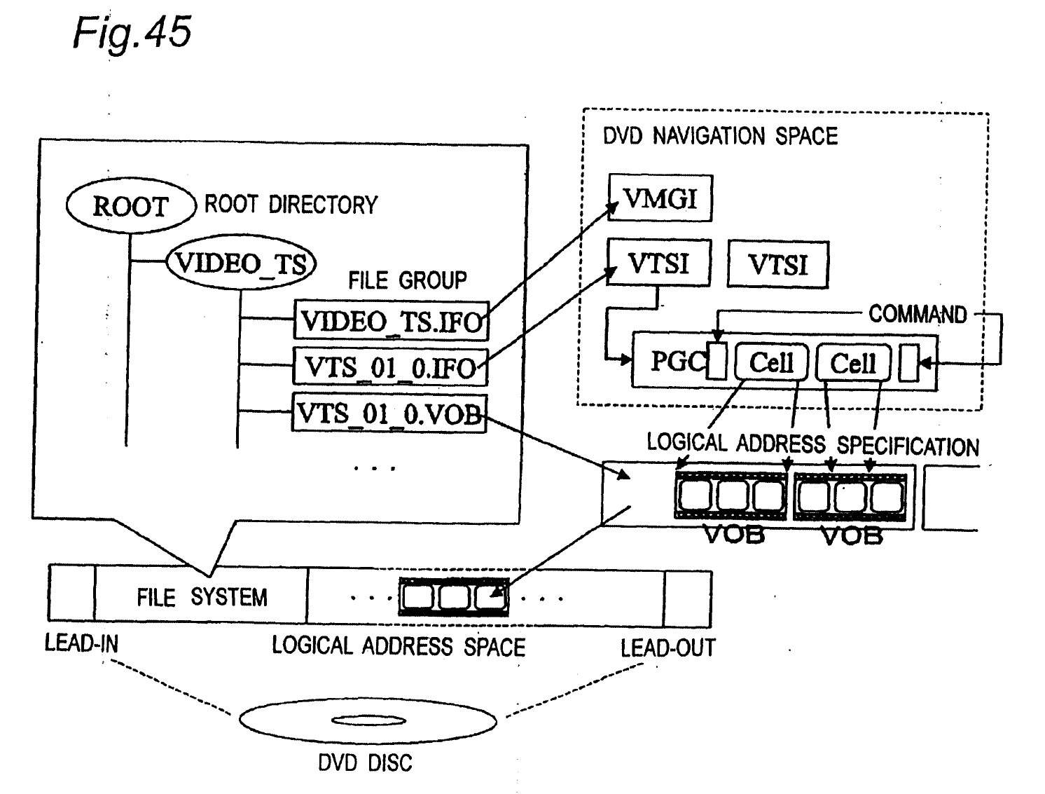

FIG. 46 describes a menu implemented with SD-DVD media;

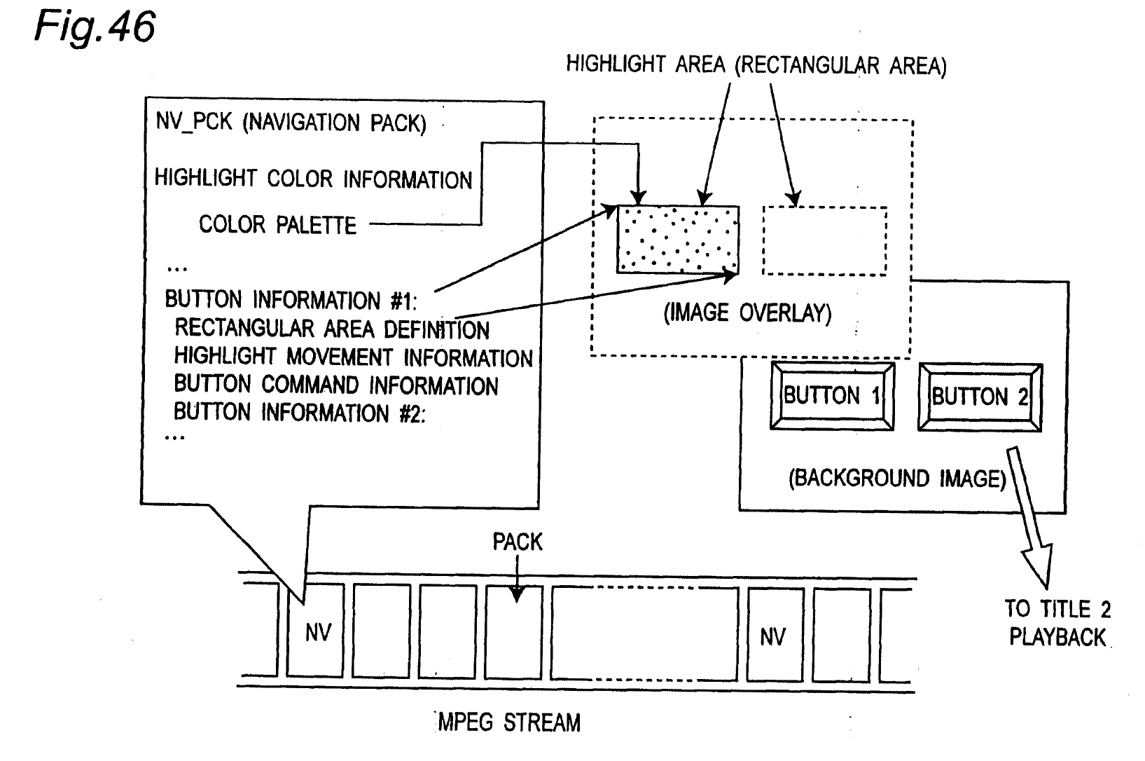

FIG. 47 describes a multipage menu implementation using SD-DVD media;

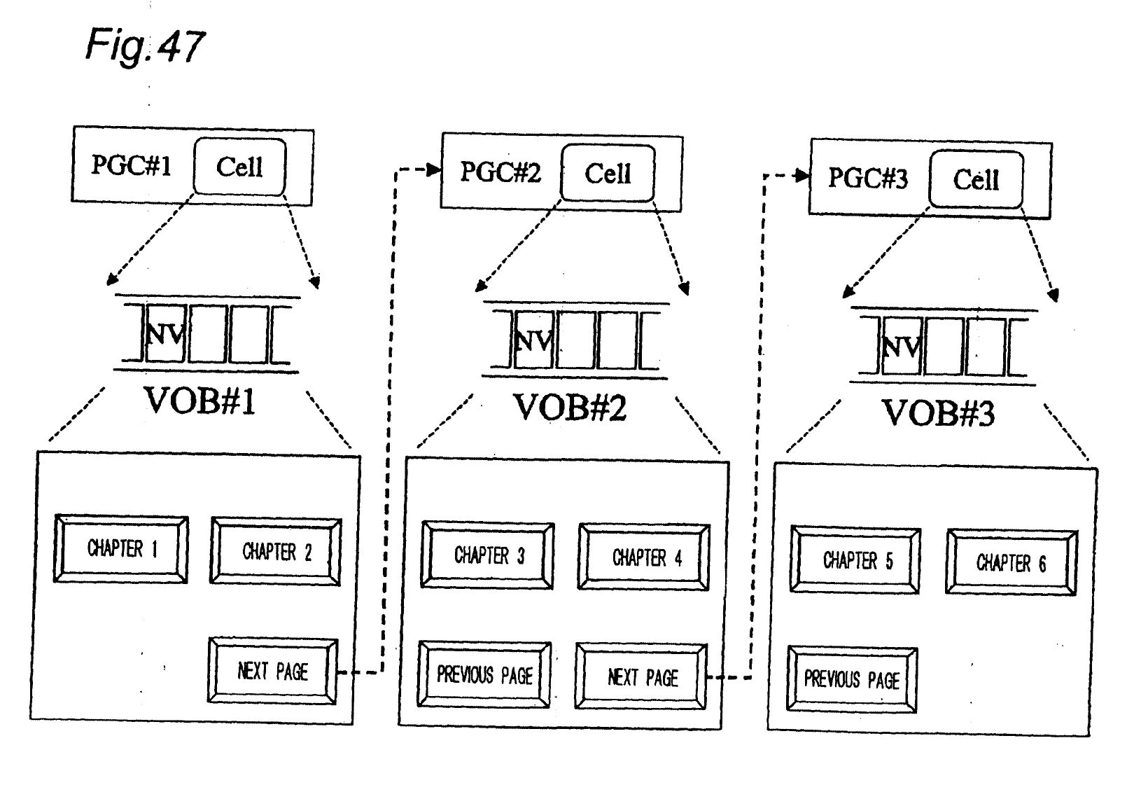

FIG. 48 describes the link between SD-DVD media and an external application;

FIG. 49 shows the relationship between cells and video objects; and

FIG. 50 shows the relationship between cells and menus.

### DETAILED DESCRIPTION OF THE PREFERRED EMBODIMENTS

(Media player configuration)

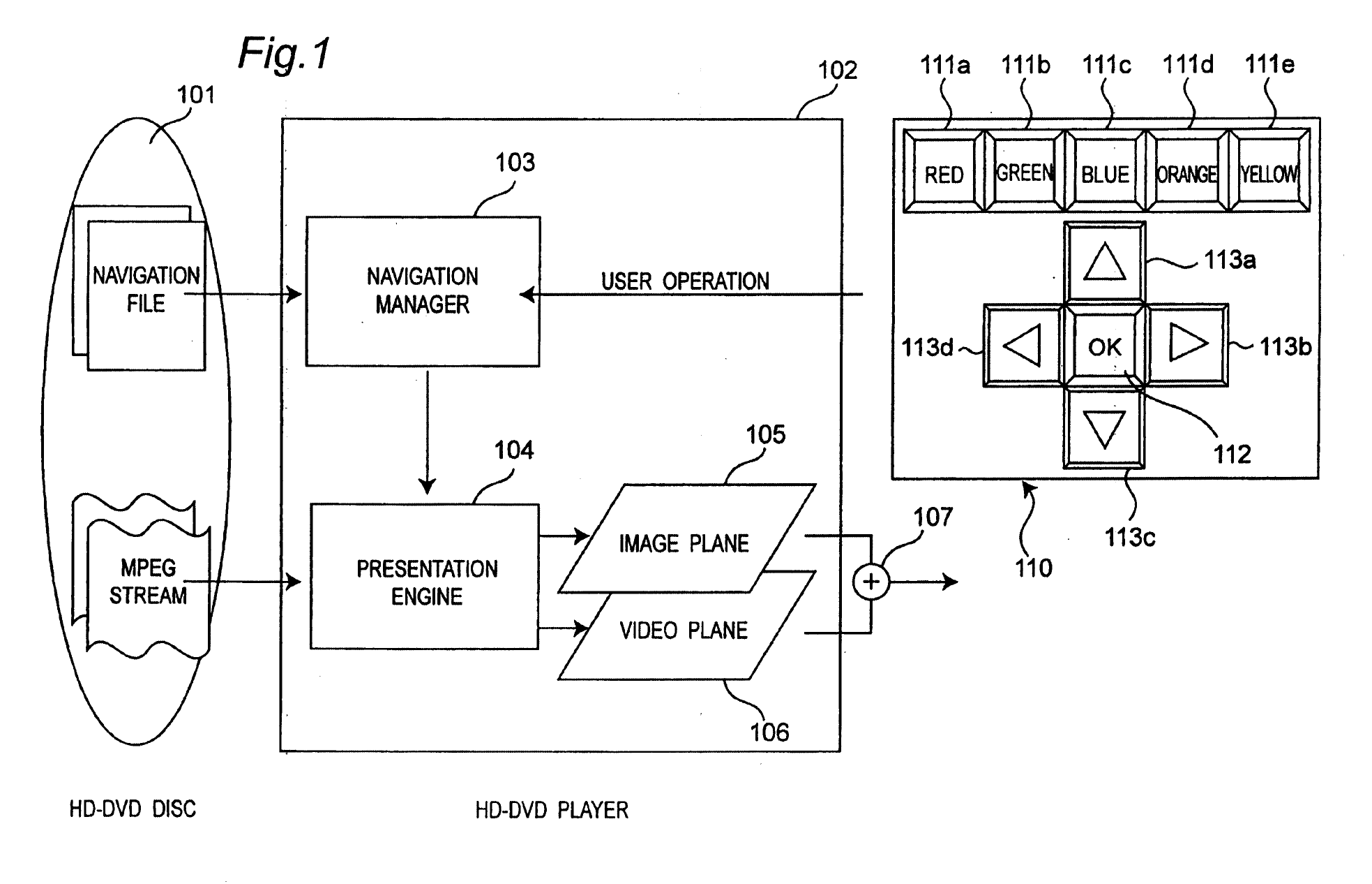

FIG. 1 is a schematic diagram of an HD-DVD media player system. This HD-DVD system has an HD-DVD disc (101) and an HD-DVD player (102). Navigation files and MPEG streams are recorded to the HD-DVD disc (101). The HD-DVD player (102) has a navigation manager (103), presentation engine (104), video plane (106), image plane (105), and image synthesizer (107). The navigation manager (103) is a management information processor for interpreting management information and navigation information and running specified processes. The presentation engine (104) decodes the MPEG stream. The video plane (106) is frame memory for temporarily storing the decoded video data (main image). The image plane (105) is frame memory for temporarily storing decoded image data (subtitles and highlight images). The image synthesizer (107) overlays the image data in the image plane (105) to the video data in the video plane (106). The presentation engine (104), image plane (105), video plane (106), and image synthesizer (107) form the video object processing unit of the present invention.

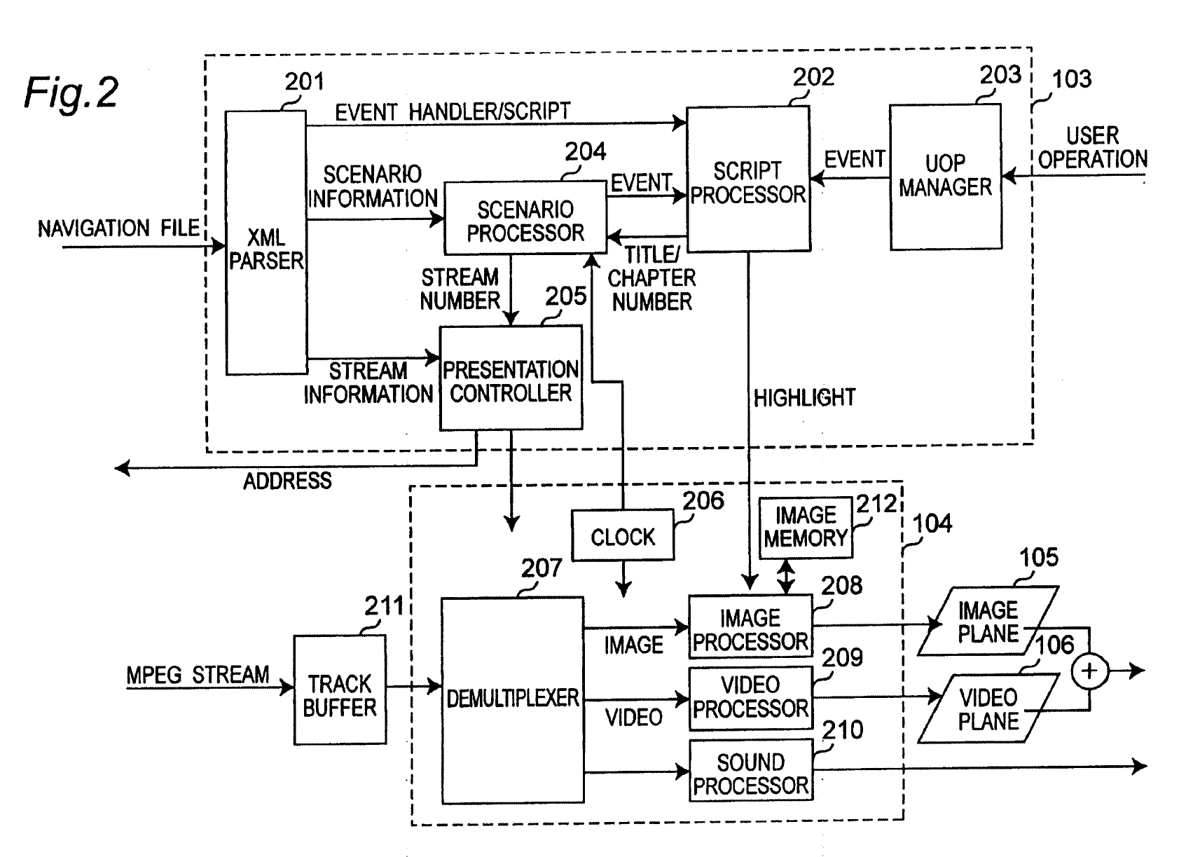

FIG. 2 is a block diagram showing the internal configuration of the HD-DVD player (102) in detail. The navigation manager (103) is composed of an XML parser (201), script processor (202), UOP (User OPeration) manager (203), scenario processor (204), and presentation controller (205).

The presentation engine (104) is an MPEG system target decoder, and is composed of a clock (206) used as a reference for the AV synchronization process, a demultiplexer (207), image processor (208), video processor (209), and sound processor (210).

The XML parser (201) reads and interprets the navigation file, and passes the scenario information to the scenario processor (204), event handlers and scripts to the script processor (202), and stream information to the presentation controller (205).

The scenario processor (204) passes the stream number of the stream to be reproduced from the scenario information to the presentation controller (205), compares time information from the clock (206) with the scenario information, and issues a time event to the script processor (202). The scenario processor (204) receives a title number or chapter number from the script processor (202) with an interrupt, interrupts or stops the title or chapter being played back, and then reproduces the specified title or chapter.

The script processor (202) receives a time event from the scenario processor (204) or a user event from the UOP manager (203), and runs the corresponding event handler.

The UOP manager (203) receives user operations, that is, signals from a remote control 110 transmitted due to user operation of a button on the remote control 110, and sends the corresponding required events to the script processor 202. As shown in FIG. 1 the remote control 110 has five buttons or keys 111a, 111b, 111c, 111d, 111e for selecting different processes (including menu selections), a button or key 112 for executing the selected process, and four cursor buttons or keys 113a, 113b, 113c, 113d for navigating the display (i.e., moving the selected item up, down, right, and left on the display).

The presentation controller (205) passes a call for a stream to be reproduced based on the stream number received from the scenario processor (204) and the stream information received from the XML parser (201) as address information to the drive. The presentation controller 205 also passes attributes of the playback stream and other required information to the presentation engine (104).

The demultiplexer (207) extracts the elementary streams from the MPEG stream and passes the streams to the corresponding elementary decoders (208, 209, 210). The image processor (208) is a decoder for decoding subtitles and highlight images. The video processor (209) is a video decoder for decoding the MPEG Video stream, and sound processor (210) is an audio decoder for decoding audio data including the MPEG Audio stream and Dolby AC3 audio. Image memory (212) temporarily stores image data when the subtitles and highlights consist of multiple images.

The clock (206) is a system clock counter as defined in the MPEG System Target Decoder, and generates the reference clock for AV data synchronization control. Output from the clock (206) is also sent to the scenario processor (204), and is for both scenario synchronization as well as AV stream synchronization.

The media player has a track buffer (211) through which MPEG streams are input to the demultiplexer (207). The track buffer (211) is a buffer for storing a predetermined amount of data so that data supply to the demultiplexer (207) does not stop during seek operations on the disc, for example.

(Scenarios and scenario playback model)

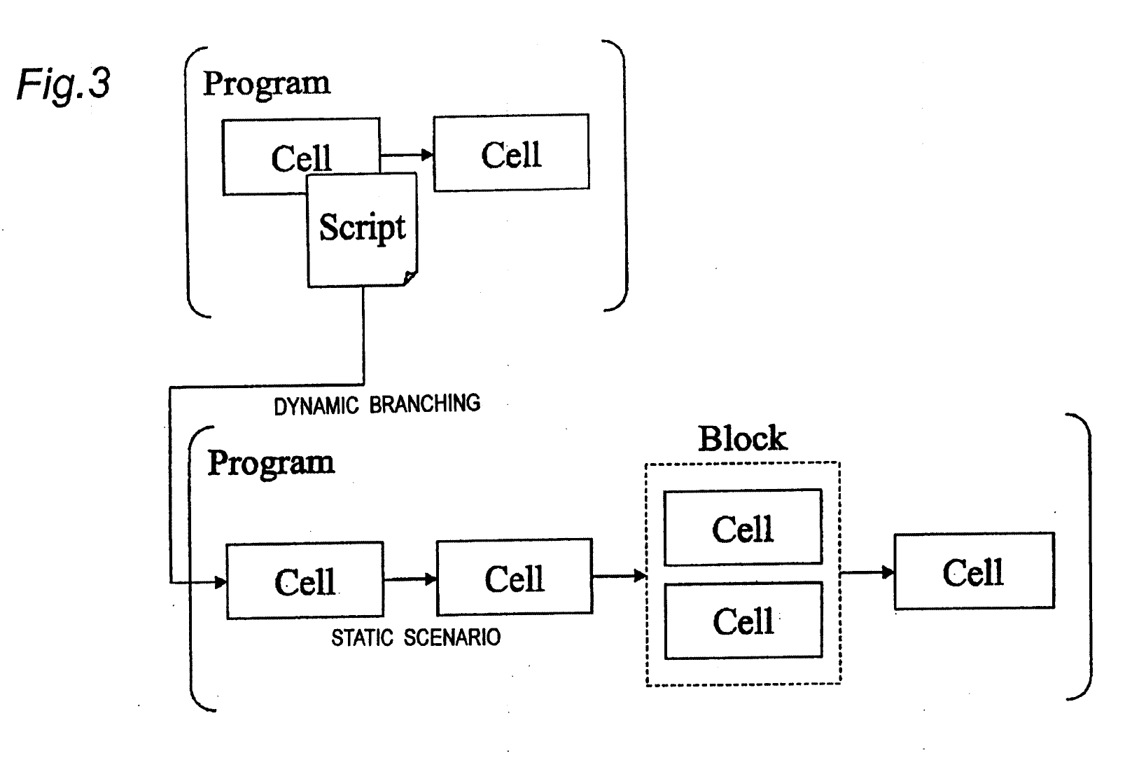

FIG. 3 is scenario structure diagram.

A scenario is a basic logic unit for HD-DVD playback control, and is composed of primarily programs and cells. A cell is one continuous playback unit, and more specifically logically dereferences all or part of one VOB (MPEG stream). It should be noted that a cell is a logical unit and is not the VOB, or stream, per se.

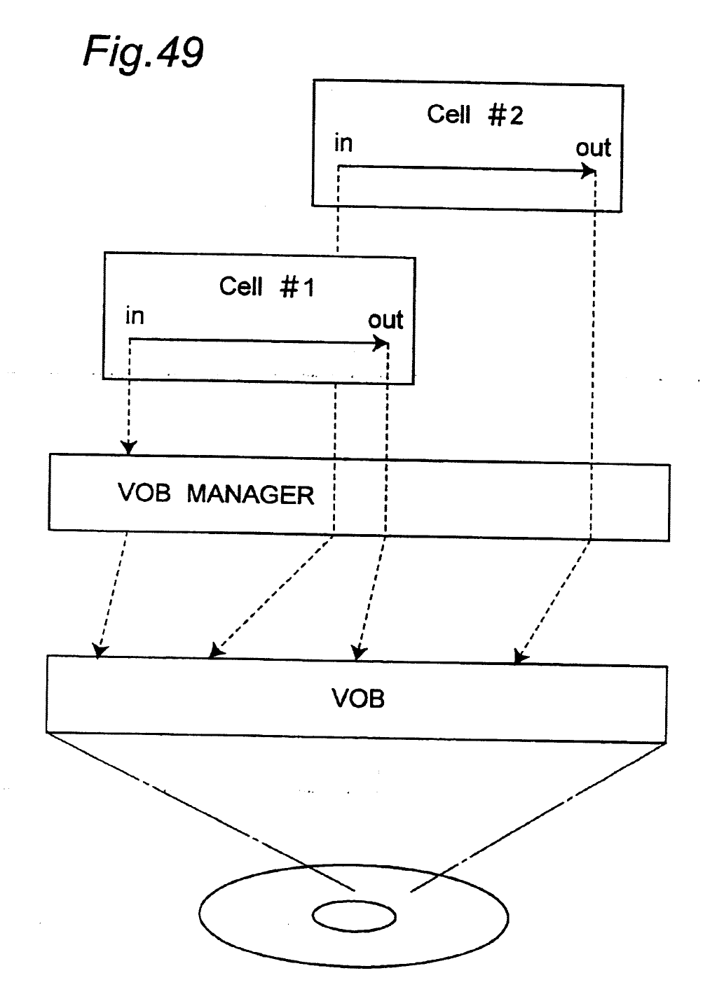

The relationship between a cell and a VOB is described next with reference to FIG. 49. As noted above a VOB 201 is an MPEG stream stored to an HD-DVD disc. Each of cell 202 contains a playback start time (in) and playback end time (out) whereby the playback section of all or part of the one corresponding VOB can be specified. The playback start (in) and end (out) times of the cell enable the VOB manager 203 to determine the address in the VOB 201. As further described below a cell can have one or multiple associated menus, and the event handler corresponding to a particular menu can be activated between the start and end times of that menu. Interactive scenarios can be achieved by an event handler that can be activated by a menu contained in a cell in a different VOB. Seek operations are therefore not needed to read an interactive scenario, and a wide variety of interactive scenarios can therefore be achieved. The amount of video data and audio data that can be stored in a single VOB is also not restricted.

Because the cell 201 is not actually the VOB, multiple different cells 202 can redundantly specify parts of the same VOB 201. Multiple different cells 202 could also point to all of a same VOB. It is therefore possible by changing the menu according to different playback paths for the same VOB to achieve a variety of interactive scenarios.

Referring again to FIG. 3, a program is a group of cells arranged in chronological (playback) order. A program is thus a static scenario. A program internally has parallel playback sections called “blocks.” These blocks are used to provide multiangle views whereby the user can select the VOB to be presented, and random shuffle playback whereby the reproduced cell is selected using a random value.

Random playback is a method of randomly selecting and reproducing the three cells in a block having three cells, for example. This selection and playback occurs the number of times specified in the scenario. If this three-cell block is programmed to play randomly three times, a process for selecting and playing one cell runs three times.

Shuffle play likewise runs a similar process for selecting and playing one cell from a block a specified number of times, but differs from random play in that once a cell is selected and played it is removed from the group of selectable cells. If a block containing three cells is specified for shuffle play, for example, the reproduced cell is first selected from the three cells, the next reproduced cell is selected from the remaining two cells, and the remaining unplayed cell is then reproduced.

A cell can have an embedded script (written in a programming language), and scenario branching can be dynamically controlled by the script.

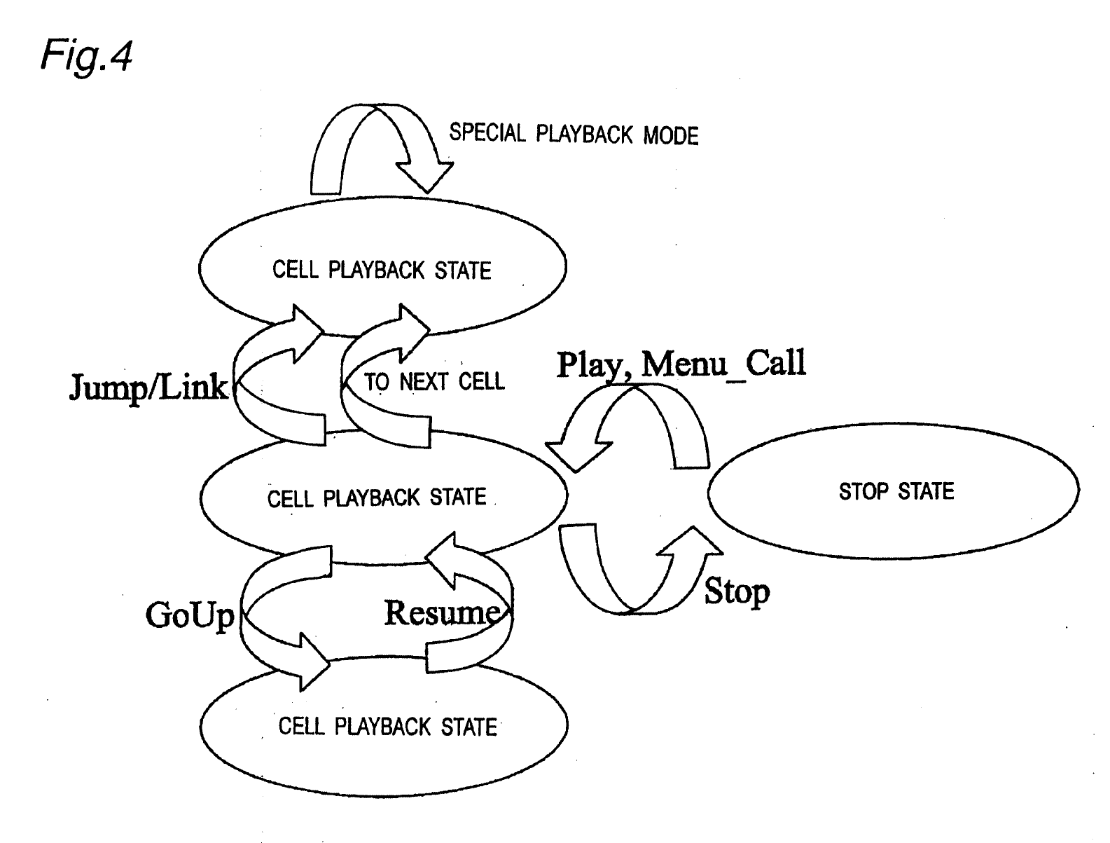

FIG. 4 is a state transition diagram for this media player.

The state transition model for this player has two states, a “cell playback state” and a “stop state”. When the player is in the “stop state” it can move to the “cell playback state” in response to a menu call or playback request from the user. From the “cell playback state”, the player moves to the “stop state” when the user applies a stop playback command, and moves to another “cell playback state” when playback moves to another cell within a program or when the reproduced cell is changed by a script command such as “Jump”, “Link”, or “GoUp” (scripts are further described in detail below). When playback goes to another “cell playback state” as a result of a “GoUp” command, the “Resume” command can be used to return to the previous “cell playback state”.

It should be noted that FIG. 4 shows three playback states, but this is for ease of understanding and description only and there are not three different playback states.

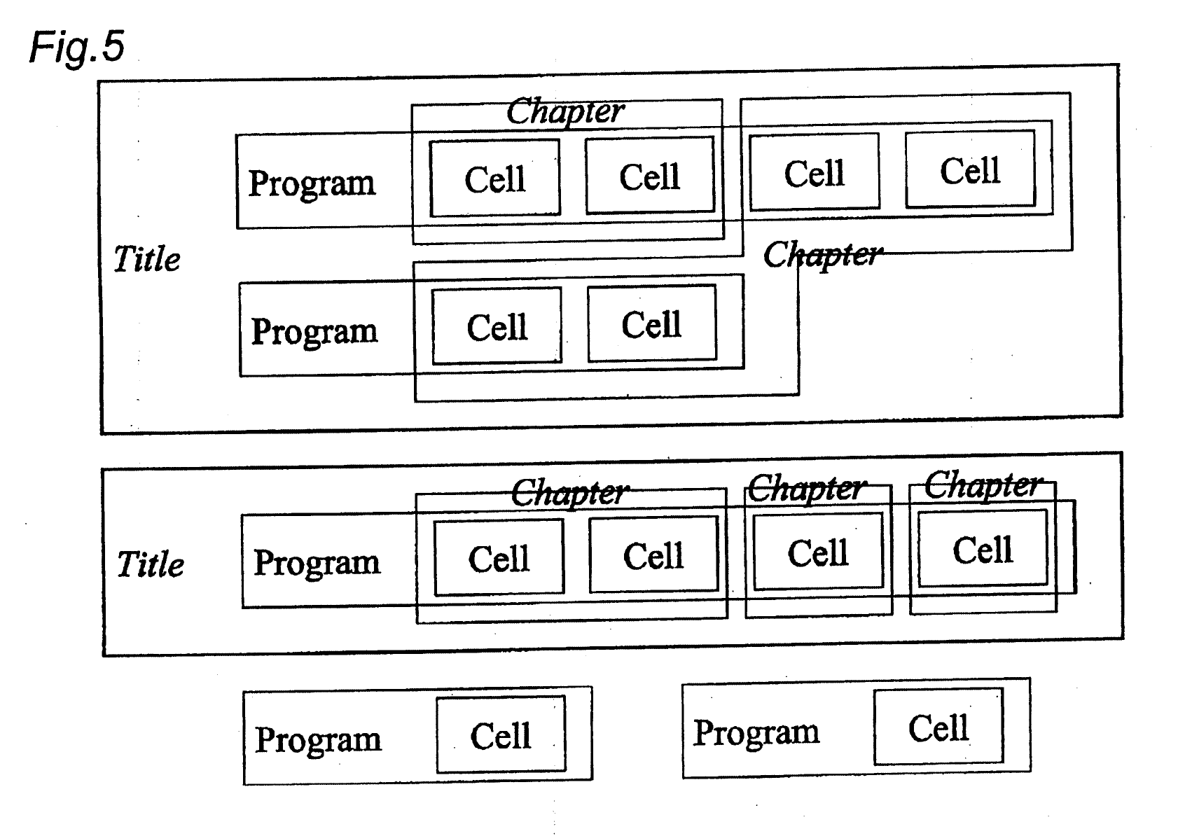

FIG. 5 shows the correlation between titles and chapters as user-recognizable units, and programs and cells.

The program and cell described above are logical units for describing a scenario, and do not necessarily match the title and chapter units to which the user refers. For example, if there are a number of dynamic branches in one title, the title consists of multiple programs. Rather than expecting the user to recognize individual non-chronologically arranged programs, it is preferable to refer to units (titles and chapters) that connect a number of programs. Furthermore, because cells are also not greater than the physical VOB units, chapters are a convenient conceptual unit of plural cells similar to this program-title relationship.

As shown in FIG. 5 a title is composed of multiple programs, and a chapter is composed of multiple cells. A chapter can include cells belonging to multiple programs, but cannot belong to different titles. A chapter is therefore a closed unit contained within a single title. Further, a single program cannot be shared by multiple titles, and a single cell cannot be shared by multiple chapters. There can, however, be programs or cells that do not belong to any title or chapter.

(Menus and event handlers).

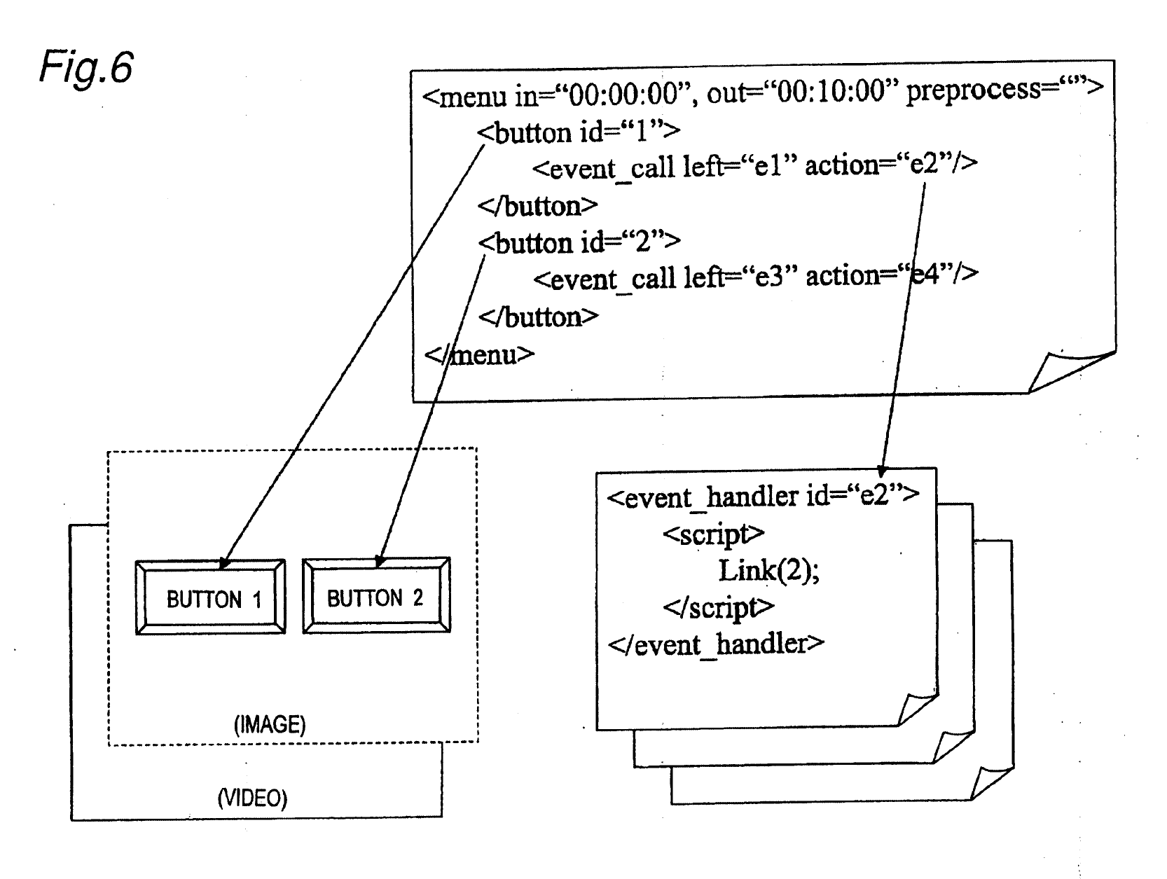

FIG. 6 shows the menu structure.

A menu structure as used in the present embodiment is a structure for implementing chapter menus as described in the prior art, and enables controlling operation in response to dynamic, that is, user-generated, events.

The buttons displayed on the menus are generated from image data. The buttons are overlaid to a background video image, and the synthesized screen image is presented on a television. Images and video are merged as described in the media player configuration above. Control of image data in the menus and control of what happens when the user selects and executes a button is described in the menu information, and the process is run by the script processor 202.

Menu information written in XML (eXtensible Markup Language) is shown in the upper right in FIG. 6.

The menu information is declared with the <menu> tag and the end of the menu description is declared with the </menu> tag. The menu start time (in) and end time (out) are declared as attributes of the menu between the <menu> tags. This time information is relative to the cell from which the menu is presented. The <menu> tags can also define the process “preprocess” executed when the menu is first displayed. Note that in this example the “preprocess” attribute is undefined (preprocess=“”).

A “menu” element can have multiple child elements “button.” Each “button” corresponds to a button presented on screen in the menu, and there are as many “button” elements declared as there are buttons displayed in the menu. Each <button> tag has an “id” attribute, which is a unique number for each button in that particular menu. The value of the “id” attribute of the first “button” element shown in FIG. 6, for example, is “1”, thus corresponding to button 1 on the screen.

Each “button” has an “event_call” child element describing the link to the event handler called in response to a user operation, i.e., the event handler invoked when the user selects that button. Attributes of the <event_call> tag are “left”, “right”, “up”, and “down” corresponding to directional cursor operations and “action” for invoking the script corresponding to the menu item selected with the cursor keys. For example, the value of the “action” attribute of the <event_call> element of the first <button> tag corresponding to the first button in FIG. 6 is “e2.” This means that when the user selects and invokes “button 1”, the event handler corresponding to “e2” is executed by the script processor 202.

The bottom right part of FIG. 6 shows an example of an event handler script.

Each event handler is declared with the <event_handler> and has an “id” attribute. The value of this “id” attribute corresponds to the “id” attribute of an “event_call”, and a match between the “id” attribute of the event handler script and the “id” attribute of the “event_call” means that the event handler and “event_call” are linked. In other words, when the user selects “button 1”, the event handler identified by the “id” attribute “e2” shown in FIG. 6 is executed by the script processor 202.

The “event handler” has a “script” child element where the script program is written between a <script> start tag and a </script> end tag. A script program is described further below.

In addition to menu buttons, event handlers can be written in the following locations and executed as indicated.

Menu preprocess (executed when a menu starts)

Menu post-process (executed when the menu ends)

Cell preprocess (executed at the start of cell playback)

Cell post-process (executed when cell playback ends)

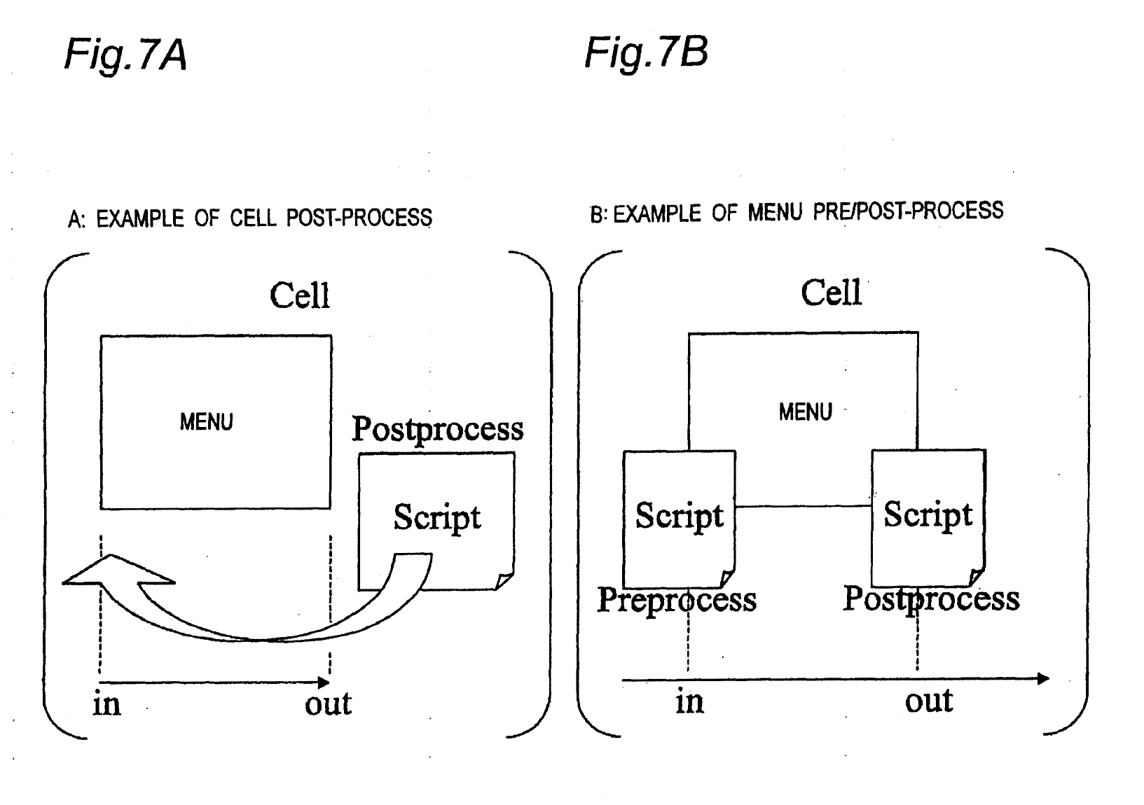

FIG. 7A shows an example of a cell post-process. A post-process is located and run after cell playback. To repeatedly play back a cell, for example, the post-process is written to reproduce the cell and the cell can thereby be repeatedly reproduced from the beginning of the cell.

FIG. 7B shows an example of a menu preprocess and post-process. The preprocess is activated simultaneously to the menu start time “in” and the post-process is activated at the menu end time “out.” Preprocesses are used mainly to initialize variables (described in detail below), and post-process are used to clean up (post operations) used in the menu.

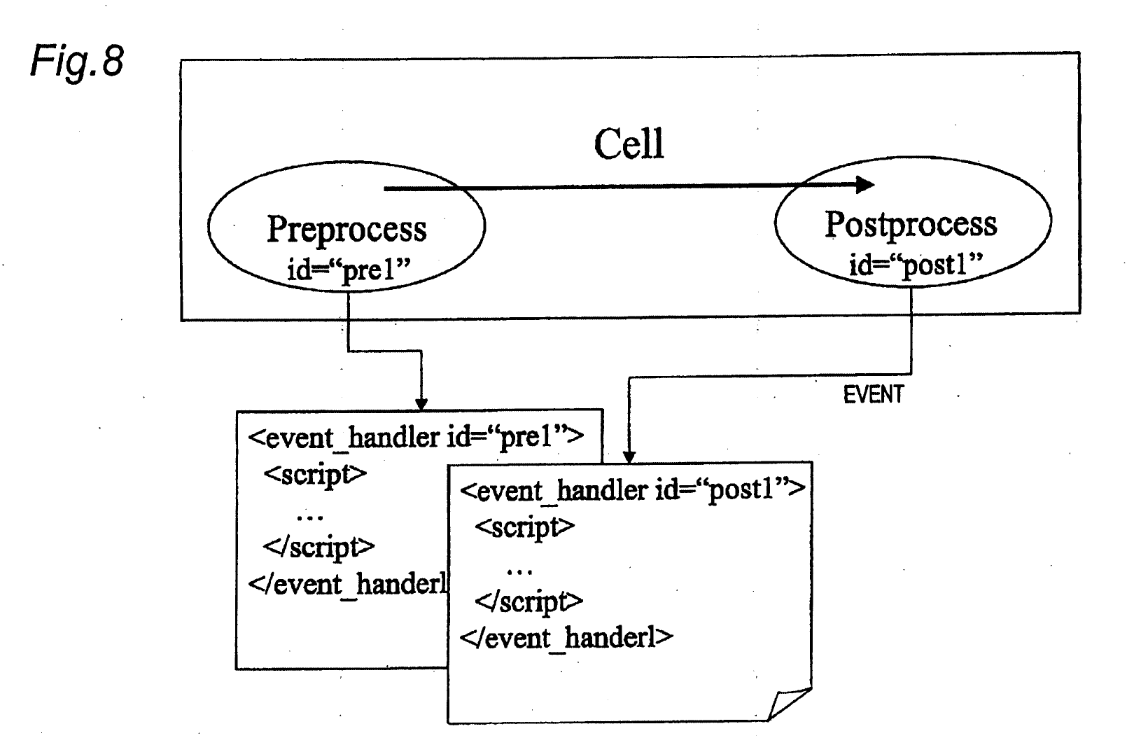

As shown in FIG. 8 each preprocess and post-process has an “id” attribute and calls the event handler identified by the “id” attribute to invoke the script in the event handler.

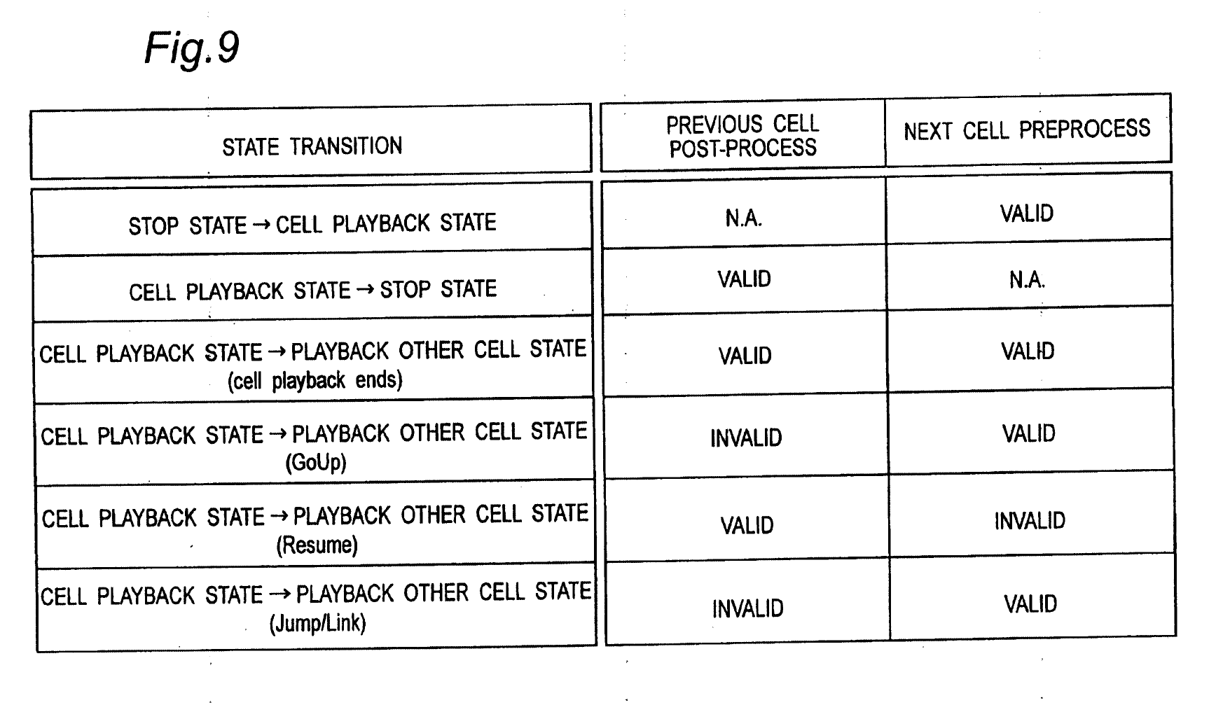

FIG. 9 is a table showing the validity of pre- and post-processes between cells and cell playback and stop states.

At state transitions during cell playback and stop states, the cell post-process and preprocess are enabled, i.e., run, when leaving the cell and when entering the cell, respectively.

When playback moves to a different cell with cell playback ending in the same program and shifting to the next cell, both the post-process and preprocess are valid. When using GoUp to move temporarily to another cell or using Resume to return to the previous cell, the preprocess, and post-process are both valid in the original cell and the preprocess and post-process are valid in the destination cell. Further, when using Jump or Link to move playback while playing one cell, the post-process is invalid in the source (original) cell from which the Jump or Link command is invoked, but the preprocess is valid in the destination cell.

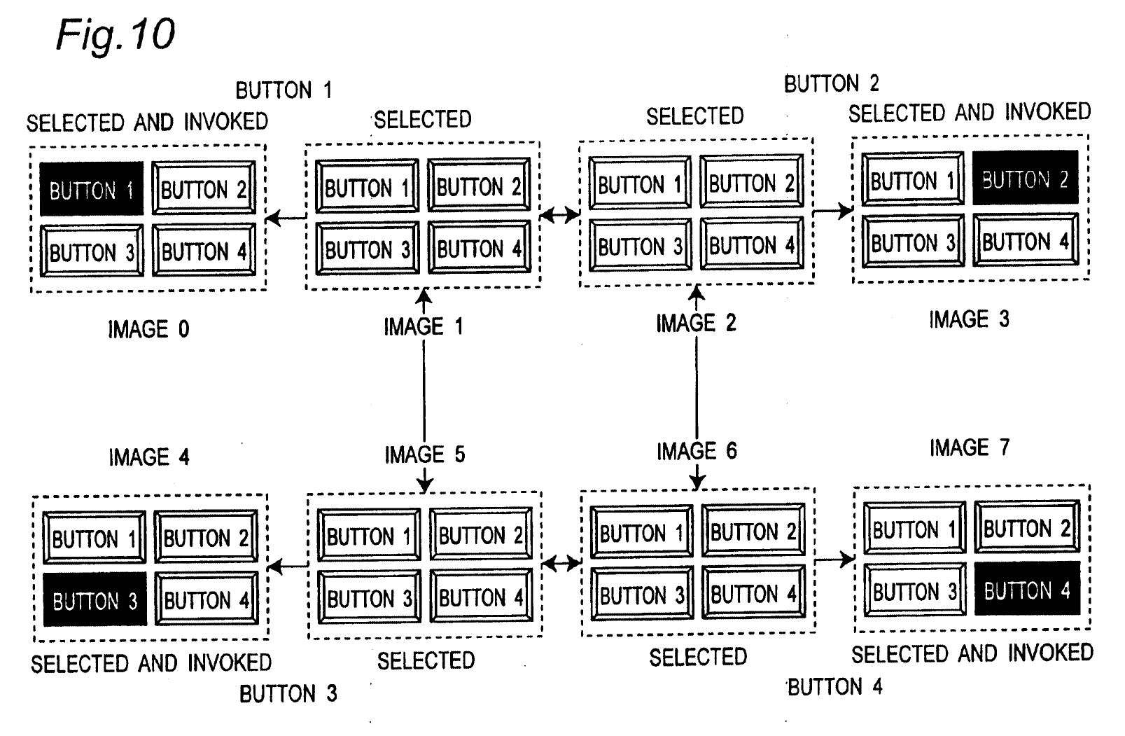

FIG. 10 describes the change in image data.

As described above, image data is displayed overlaid to the main video. Menu buttons are drawn in the image data and not the main video with both selected and deselected buttons drawn in the image data. Plural images are combined in a linked set with one image selected and drawn on screen from the images in the set.

For a menu with four buttons, for example, there are eight different images in the image data set. These include four images in which a different button is selected in each image, and four images in which a different selected button is activated. One menu is thus displayed using eight different images with the appropriate image selected and displayed according to which button is selected and operated.

The example shown in FIG. 10 and described above has the following eight images the appropriate image selected and displayed according to which button is selected and operated.

Button 1 selected

Button 1 selected and operated

Button 2 selected

Button 2 selected and operated

Button 3 selected

Button 3 selected and operated

Button 4 selected

Button 4 selected and operated

When the menu is first displayed “button 1” is highlighted, indicating that it is selected. “Image 1” in FIG. 10 is displayed at this time. The user can select a different button using the cursor keys, or activate the script associated with the selected button using the select or enter key, of the remote control. Pressing the right cursor key when “button 1” is selected moves to “button 2”, pressing the down cursor key moves to “button 3”, and pressing the select key executes the action associated with “button 1”.

If the user presses the right cursor key on the remote control when “button 1” is selected, Image 1 in which “button 2” is selected is displayed. Similarly if the down cursor is pressed, then Image 5 in which “button 3” is selected is displayed. If the select key is pressed, image 0 in which “button 1” is selected is displayed.

Each image is stored as a single frame with all images used to display the actions available from one menu grouped in one “image unit” multiplexed to a VOB. The order of the frames in the image unit corresponds to the sequential number assigned to each image.

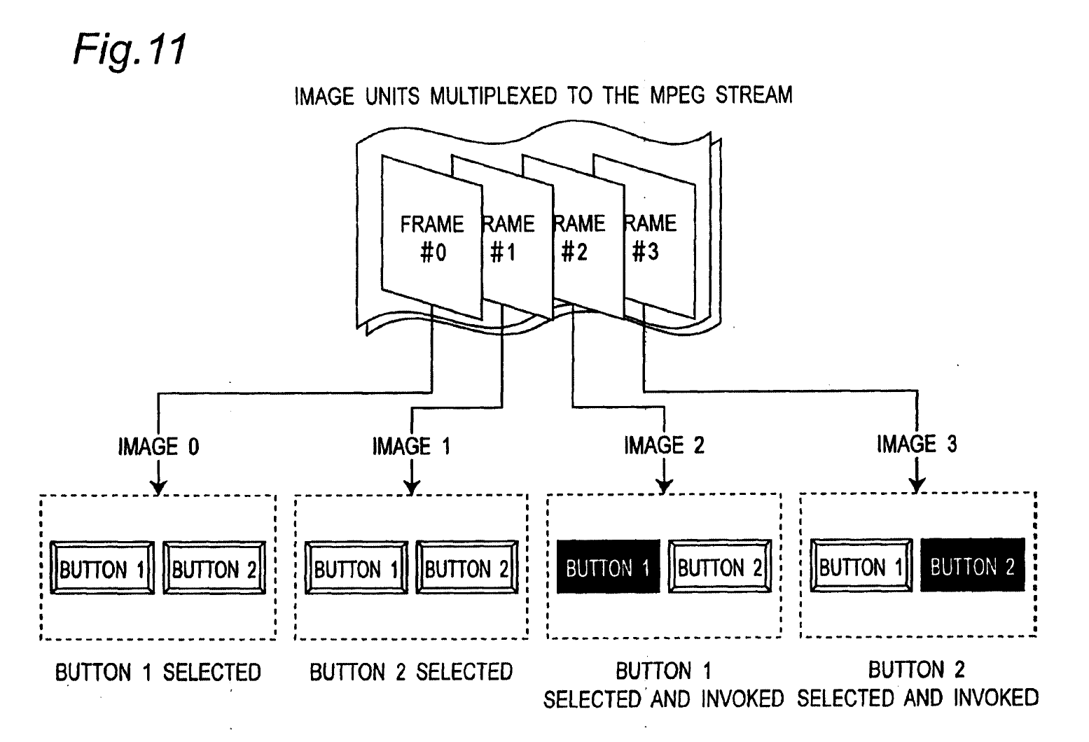

FIG. 11 shows an example in which there are two buttons in a menu. This example uses four images:

Button 1 selected

Button 1 selected and operated

Button 2 selected

Button 2 selected and operated

These states correspond to image 0, image 1, image 2, image 3, which correspond to frame 0, frame 1, frame 2, frame 3 in the image unit. The script of the event handler activated by each button is programmed to display the image representing the result of the user action (navigating to a different button or invoking a selected button), thereby changing the display to the appropriate image. These four images are stored in image memory 212, and the appropriate image is selected from image memory 212 and drawn on the, image plane.

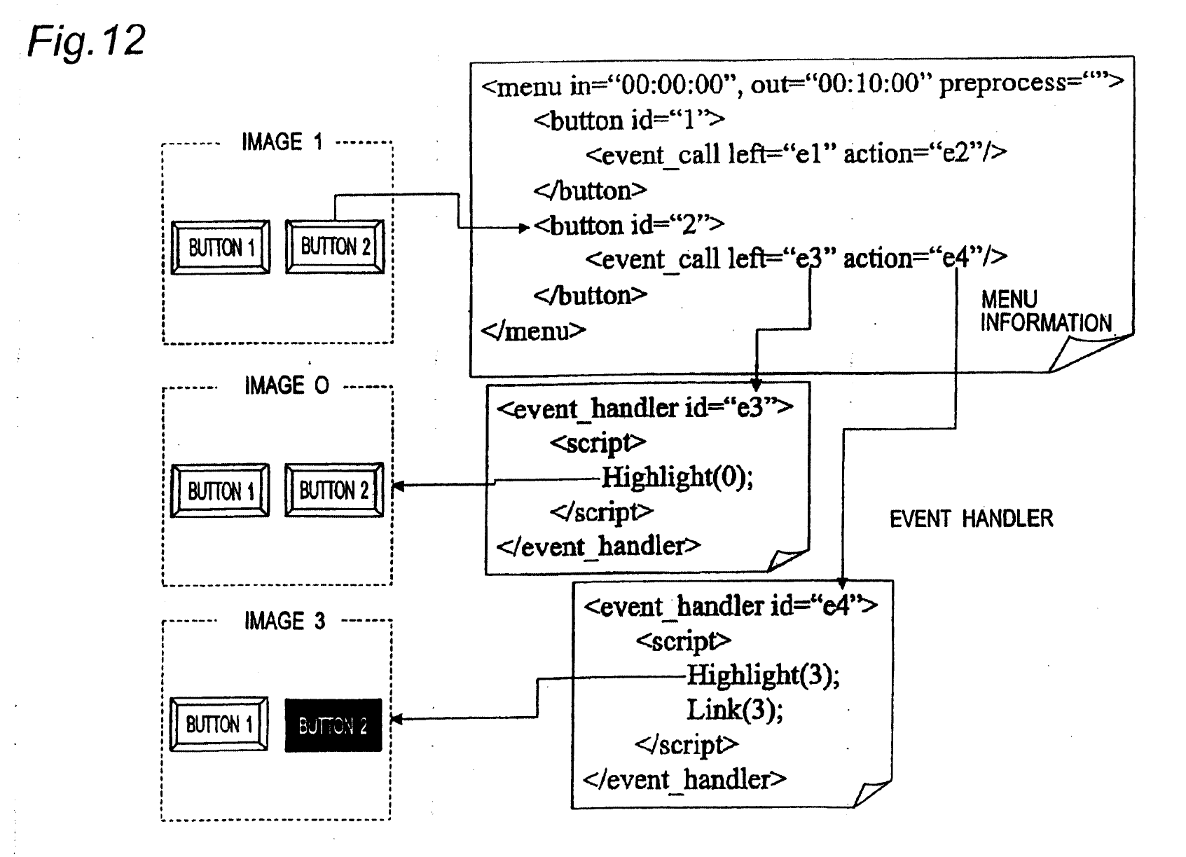

FIG. 12 describes the relationship between navigation data and images.

Assume to start that image 1 is displayed with button 2 selected. The navigation data declares that the menu information includes two buttons, and each button has its own ID and event handler link. The event call (event_call) attributes of the button 2 script are left=“e3” and action=“e4” corresponding to actions for selecting the left. key and invoking the selected button.

If the user presses the left cursor key on the remote control, the event handler of id=“e3” is invoked and the event handler script runs. In the example shown in FIG. 12, the event handler calls the “Highlight(0)” denoting displaying “image 0”, thereby causing the menu to change from “image 1” to “image 0”.

If the user presses the select key on the remote control when image 1 is displayed (button 2 is selected), the event handler identified by event handler id=“e4” is invoked and the internal script is time processed. In the example shown in FIG. 12 the “Highlight(3)” command for displaying image 3 is called and the menu changes from image 1 to image 3. The “Link(3)” command on the next line is then called to start playback of cell #3.

Image display can thus be controlled so present the menu image appropriate to user actions using the menu structure and event handlers as described above. It should be noted that different button states (actions) are indicated by adding color density to the buttons in the example described above, but other methods could be used to indicate different button states. For example, the selected button could be displayed larger than the other buttons, a different color could be applied, the button patter could be changed, or the button could be redrawn from a simple rectangle, for example, to an oval or star shape (i.e., with serrated edges).

The event handler script is described in further detail below.

In addition to menu buttons and menu and cell preprocesses and post-processes, event handlers also handle other user operations. These are called global event handlers and are invoked when a user invokes a menu call (a user operation calling a title menu or chapter menu, for example, such as commonly used with DVDs) during title playback (or more precisely, during cell playback).

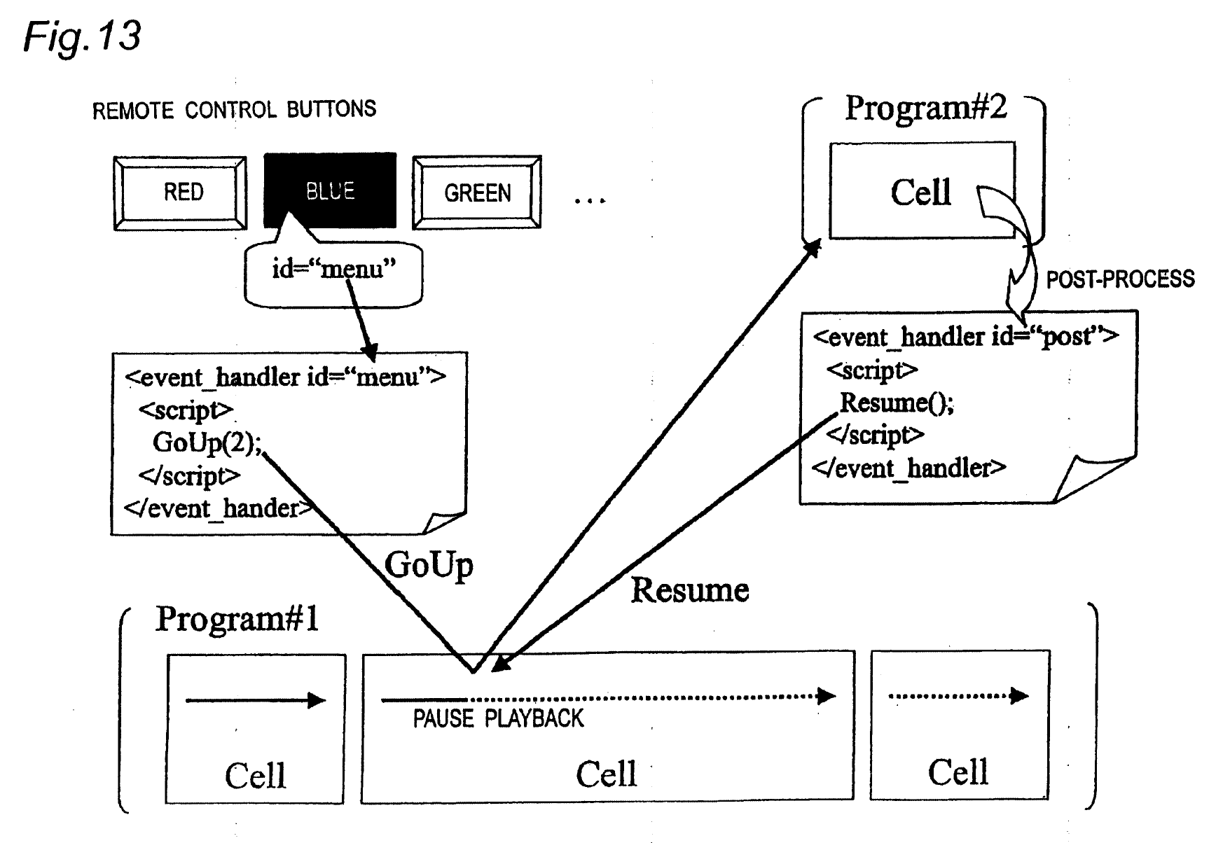

Global event handlers are described with reference to FIG. 13.

Assume that there are five dedicated keys on the remote control (these are referred to here as keys simply for easier distinction from the buttons displayed as images in the on-screen menus). Each key has a unique color, specifically “red”, “blue”, “green”, “yellow”, and “orange” in this example, and the keys are accordingly referred to as the red key, blue key, green key, yellow key, and orange key. Conventional DVD players have a number of dedicated keys for performing specific functions, such as a “TITLE key” for calling the title menu. The relationship between the physical keys and available functions is determined in the present invention by the title producer. As a result, a particular key might not be used (i.e., not enabled).

The five dedicated keys are each linked to a global event handler so that when the user operates a particular key the corresponding global event handler is called. In the example shown in FIG. 13 the blue key is set to id=“menu” so that when the blue key is pressed the event handler with id=“menu” is called. The script of this event handler has the command GoUp(2), telling the player to interrupt playback at the current position and play program #2. The location where playback was interrupted is written and stored to a variable in the player for a subsequent Resume operation (if called).

When program #2 is played the cell post-process is called last. In FIG. 13 the event handler with id=“post” is called, and playback continues with the script command Resume( ), that is, from the location where playback was interrupted by the GoUp command.

Program #2 has a menu structure presenting, for example, an audio selection menu enabling the user to change the audio source to, for example, switch from English to Japanese. Playback can then be returned by the post-process to where playback was interrupted when program #2 was called.

(Parental control)

One of the functions implemented with DVD media is the so-called parental control feature. Parental control is a function enabling the DVD player to impose access control to disc content. This access control is roughly comparable to PG-18 and other movie ratings used at movie theaters. Many movies contain scenes with violence or sex, and depending on the content such movies may earn a PG-18 rating preventing unaccompanied minors from entering the movie theater. With sell-through DVD titles, however, an adult could purchase a PG-18 rated title and children could view the title while the parents are not home, for example. To prevent this the parent can use the parent control feature to preset the player to block access to selected content. The player then compares the parental control rating of the title with the access setting of the player to determine whether the title can be played. If the title is determined unplayable (due to impermissible content), the player will not play the disc.

With DVD, however, it is also possible to change the playback scenario instead of completing prohibiting playback. A PG-18 movie typically has only some scenes with violence or sex. Therefore, instead of prohibiting access to the entire movie, it is possible to remove or substitute other scenes for those rated objectionable.

Viewing restrictions may also differ by country or region, and the DVD format enables these restrictions to be enforced using different settings by country or region, for example.

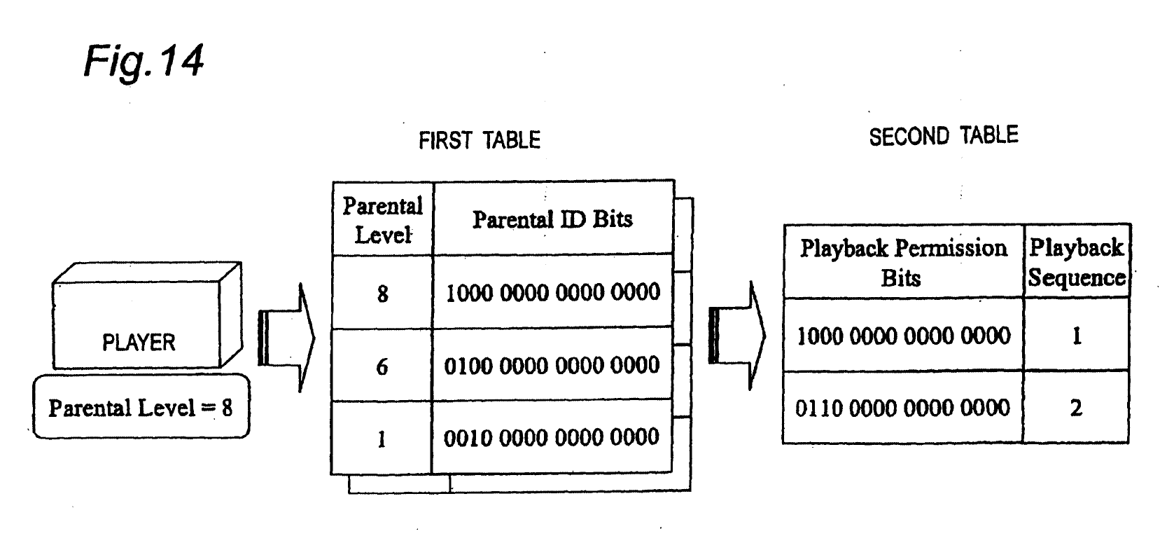

FIG. 14 describes the concept of the parental control (lock) feature.

The player has viewer restriction variable called “Parental Level”. The navigation information also contains two tables, i.e.

a “Parental Level-Parental ID Bits” and a “Playback Permission Bits-Playback Sequence”.

The Parental Level stored in the player is converted to a Parental ID Bits value by the first table. In this example the Parental Level is set to “8”, which is converted to Parental ID Bits=“1000 0000 0000 0000” from the first table in FIG. 14.

The Playback Sequence corresponding to this Parental ID Bits value is then acquired from a second table. In this example an AND process is applied to the Parental ID Bits and Playback Permission Bits, and a Playback Sequence is selected if the result is true. In this example Playback Sequence=“1” is selected where the value of the Playback Sequence denotes the scenario to be reproduced.

Viewing restrictions determined by country or region can be applied by providing multiple first tables and selecting the first table corresponding to the region code set for the player.

(Time map)

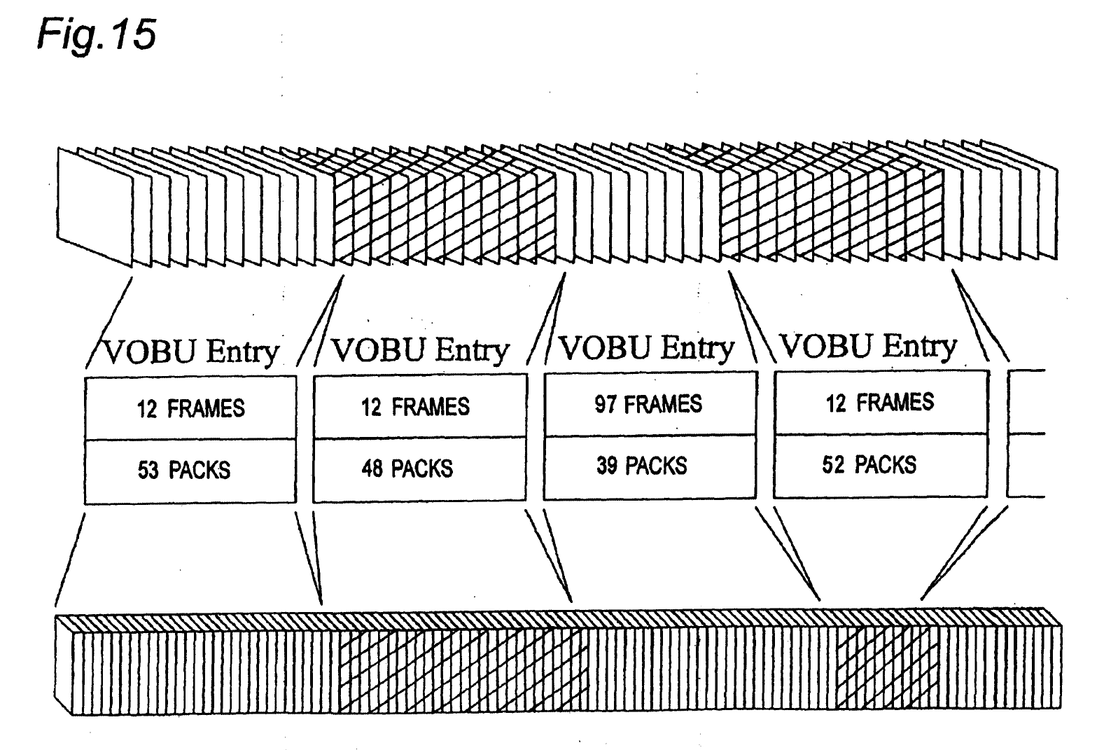

The time map is described next with reference to FIG. 15. A time map is a table needed for VOB (MPEG stream) access. As is widely known, an MPEG stream is compressed with VBR (Variable Bit Rate) coding, and the amount of data stored per time unit is changing by the time due to high compression. In other words the amount of data from the start of MPEG stream compression to ten minutes later is not simply twice the amount of data to five minutes. This means that to jump to a point ten minutes from the beginning of the stream it is necessary to read data from the beginning to determine where the data corresponding to the ten minute point is recorded. Accordingly, it takes ten minutes to find the desired location.

The time map is a means of solving this problem. As shown in FIG. 15 the time map is a table containing the number of video frames (or fields or other time-based unit) in each VOBU (Video Object Unit, corresponding to a GOP) and the number of packs (or other data size information).

For example, to jump to a point 10 minutes from the beginning the number of video frames is added in order from the first VOBU in the time map to find the VOBU at 10 minutes from the beginning. The address of that VOBU is then calculated from the time map. This is done by reading the time map to accumulate the number of packs in order from the first VOBU to the VOBU immediately preceding the VOBU containing the 10 minute point.

While described more fully below, each VOB is recorded in a separate file. Playback from the desired time point (VOBU) is therefore executed by seeking the address determined from the first VOBU and starting reading from that point.

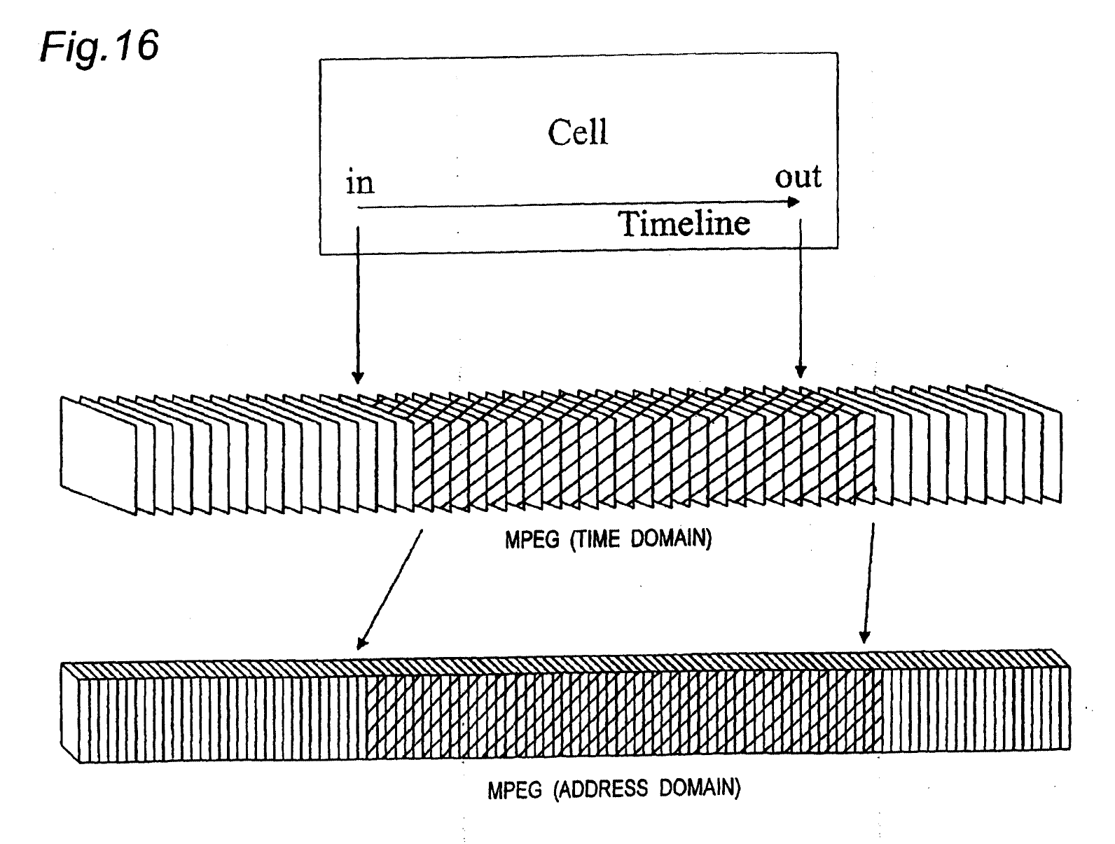

As shown in FIG. 16 each cell information element contains the corresponding VOB and the cell start and end time in that VOB. The start and end addresses can therefore be acquired from the start and end time information using the time map as described above, and the media player can thereby reproduce that cell.

The appropriate address information can also be calculated from the time map when the user executes a time search, that is, specifies a time from which playback is to begin, and is not limited to the cell playback process.

(Interleave block)

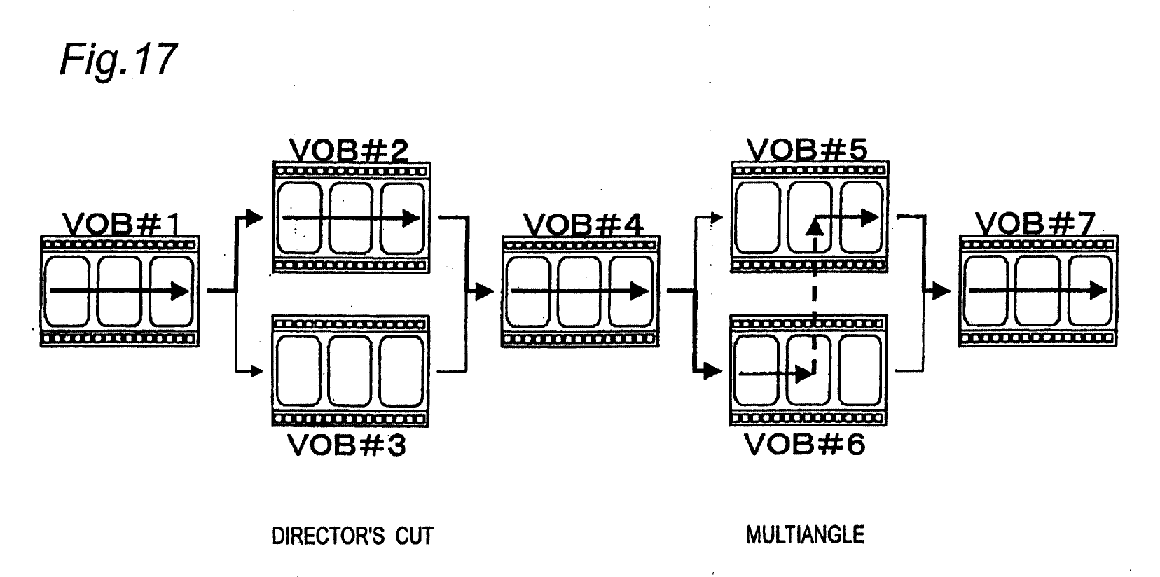

DVD (SD-DVD and HD-DVD) media, have interleave blocks in which multiple VOB are recorded interleaved on the disc. In general VOB data is recorded continuously in the reading sequence to disc to prevent unnecessary disc seek operations. In a number of applications that are possible with DVD media as shown in FIG. 17, however, these VOBs cannot be continuously recorded.

As shown in FIG. 17, all VOB cannot be recorded continuously to the disc with such applications unique to DVD media as the director's cut and multiangle views. VOB #1 is the first VOB reproduced in FIG. 17, but either VOB #2 or VOB #3 could be played after VOB #1 depending upon the scenario selected by the user.

For example, VOB #2 might include the scenes as the title was released to theaters, while VOB #3 includes premium scenes not in the theater version. Whether VOB #2 or #3 is played, that is, whether the theater-release version or the director's cut version is viewed, can be selected either before playback begins or while VOB #1 is playing. If VOB #2 is normally played after VOB #1, for example, then playback can continue from VOB #1 to VOB #2 without involving a seek operation by recording VOB #2 contiguously to VOB #1 on disc. The disc player can therefore continue reading VOB #1 and VOB #2 data without interruption. In this case the recording sequence on disc is VOB #1-VOB #2-VOB #3.

If these VOB are physically recorded in this sequence and the user chooses to view VOB #3 after VOB #1, however, a disc seek is required between VOB #1 and VOB #3. It is possible in this case that data supply from the disc will be interrupted and playback will therefore also be interrupted by the seek. This can, of course, be avoided by providing the disc player with a track buffer, but the track buffer can only sustain data supply during the seek for a limited time, which may not be sufficient to reach VOB #3 skipping VOB #2.

On the other hand, if the distance (time) jumped by the seek operation is sufficiently short, data supply can be sufficiently complemented by the track buffer. DVD media solve this seek problem by segmenting two (or more) VOB into a number of blocks and recording these blocks from the multiple VOB interleaved on disc.

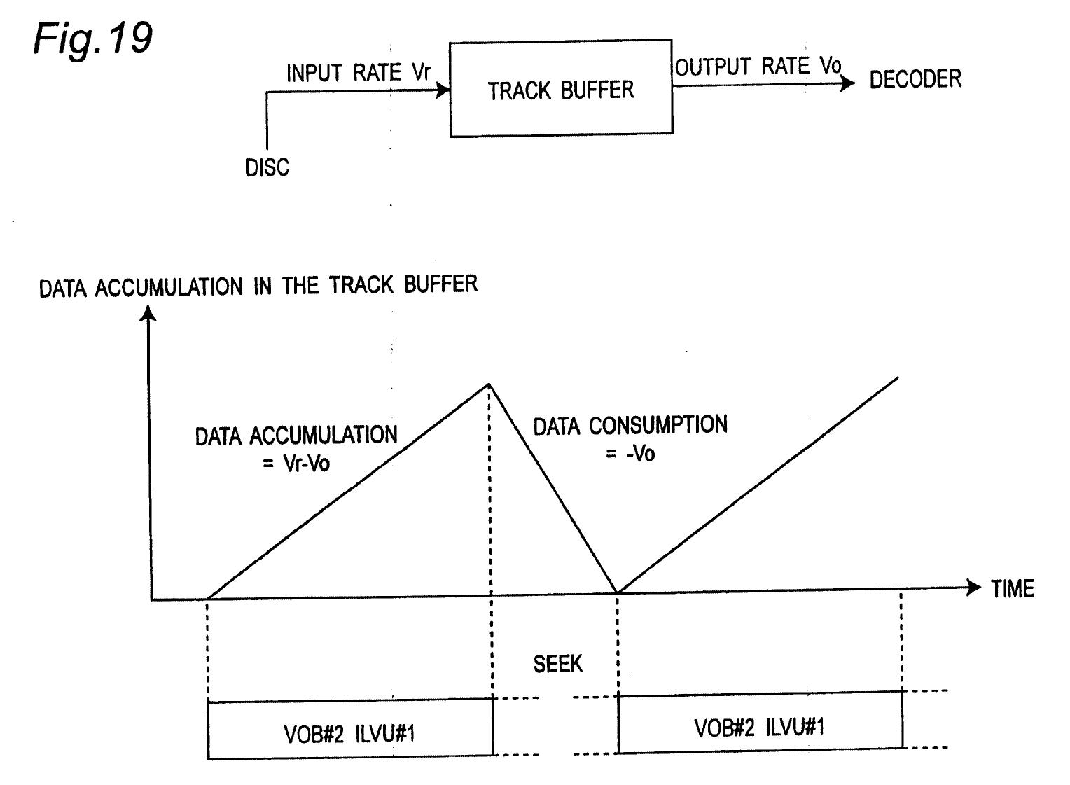

FIG. 19 describes the relationship between interleave blocks and track buffer 211. As shown in the top row of FIG. 19 the track buffer 211 is positioned between the disc (drive) and decoder, receives input data from the disc (drive) at input rate Vr and sends data to the decoder at output rate Vo. By providing a slight difference between Vr and Vo data steadily accumulates in the track buffer 211 while reading data from the disc. The bottom row of FIG. 19 is a graph showing change in data accumulated in the track buffer over time. While reading ILVU #1 at the beginning of VOB #2, data accumulates in the track buffer 211 at the rate Vr-Vo. After reading ILVU #1 ends the drive seeks ILVU #2 in VOB #2. During this seek operation data input to the track buffer 211 stops and data is therefore consumed from the track buffer 211 at bit rate-Vo.

If the seek time is shorter than the time needed to consume all accumulated data, playback of VOB #2 in the interleaved blocks can continue without interruption. The same applies to VOB #3.

If an infinitely large track buffer could be used the interleave blocks could be any size, i.e., a single VOB could be recorded without being segmented. This is, however, impractical and VOBs must be segmented to a size whereby data supply by the track buffer can be assured.

(Variables and scripts)

As described with reference to FIG. 2, a disc player according to the present invention has a script processor. Scripts are a type of programming language, one common example being the Java® Script language commonly used on the Internet. Scripts are used in HD-DVD for title playback control, and particularly to handle the process run when a user request is received such as from a menu. Variables are also provided and can be used freely by script programs. Player settings, such as the title number currently being played, can also be dereferenced by a script, and can be used for conditional processing.

The present embodiment uses two variable types: general variables and system variables.

Sixteen general variables are provided and can be freely used by a script. General variables are identified by the GV prefix and uniquely identified by a variable label from 0 to 15, inclusive. An example of a valid general variable is GV0.

There are 32 system variables. These can be referenced by a script. The system variables are used to get disc player settings, and cannot be replaced by a value from a script. System variables are identified by the prefix SV and uniquely identified by variable numbers 0 to 31. An example of a valid system variable is SV0.

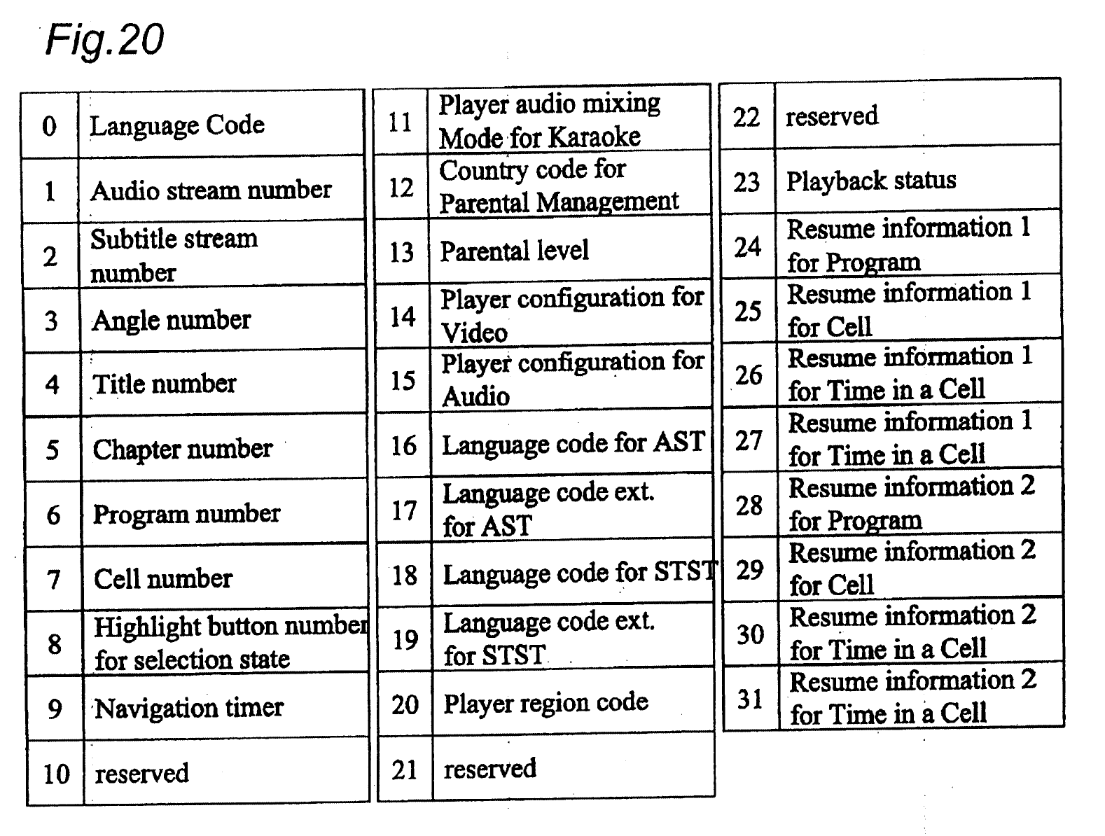

A table of exemplary system variables is shown in FIG. 20 and described below.

SV0: language code

SV1: audio stream number

SV2: subtitle stream number

SV3: angle number

SV4: title number

SV5: chapter number

SV6: program number

SV7: cell number

SV8: number of selected highlight button

SV9: navigation timer

SV10: reserved

SV11: karaoke mixing mode

SV12: parental control country information

SV13: Parental Level

SV14: player setting (video)

SV15: player setting (audio)

SV16: audio stream language code

SV17: audio stream language code (extension)

SV18: subtitle stream language code

SV19: subtitle stream language code (extension)

SV20: region code

SV21: reserved

SV22: reserved

SV23: playback state

SV24: resume information 1 (program number)

SV25: resume information 1 (cell number)

SV26: resume information 1 (time, high bit)

SV27: resume information 1 (time, low bit)

SV28: resume information 2 (program number)

SV29: resume information 2 (cell number)

SV30: resume information 2 (time, high bit)

SV31: resume information 2 (time, low bit)

Scripts are described next.

A script is written between a <script> start tag and a </script> end tag, and conforms to the Java® Script or other script specification as described in further detail below starting with the four arithmetic operations.

As used in other scripting languages, the following operations are allowed: substitution or assignment “=”, addition “+”, subtraction “−”, multiplication “*”, division “/”, and modulus “%”.

For example:

GV3=GV3+100;

adds 100 to GV3 and assigns the result to GV3.

GV2=GV2% 5;

divides GV2 by 5 and assigns the remainder to GV2.

GV1=GV1/GV2;

divides GV1 by GV2 and assigns to quotient to GV1.

Scripts can also use the Boolean operations AND “&”, OR “|”, and Exclusive OR “\hat{ }”. For example,

GV10=GV9 & GV3;

gets the AND of GV9 and GV3 and assigns the result to GV10.

A script can also generate a random value using the random( ) function as follows.

GV1=random( );

The process executed by a script can also be conditionally changed. Available conditions include the common if—then—else condition, break to interrupt a process, and goto to jump to a different part of the script. A script could conditionally assign GV11 as follows:

if(GV10 >100){

GV11=1;

}else{

GV11=0;

}

Another sample script is:

if(GV10>100){

goto error;

}

GV10=100;

break;

error:

GV10=0;

In addition to conventional operations such as described above, scripts according to the present invention also support functions for controlling DVD playback. Commands enabling DVD playback control include Jump and Link for starting playback of a program or cell.

Jump is used to move playback from one program to another program or cell. Parameters of the “Jump” are the destination program number and cell number as follows.

Jump(program number, cell number);

Link is used to move playback to another cell in the same program currently being reproduced. The destination cell number of the “Link”is written as an argument of the Link command in the script as follows.

Link(cell number);

In addition to Jump and Link, GoUp moves to the first cell in another program. The GoUp command also stores the program, cell, and time information when the GoUp command is invoked to system variables for later use by the Resume command. The Resume command can then be used to resume playback from the point at which playback was interrupted by the GoUp command. These commands can be used as follows.

GoUp(15);

Resume( );

The program, cell, and time information from playback to immediately before GoUp was invoked is recorded to the above-described system variables SV24 to SV27. When a script contains the Resume command, the player uses the values stored to SV24 to SV27 to return to and resume playback from where it was interrupted. The time information is converted to an appropriate address value using the time map so that playback can continue from the appropriate position in the VOB.

If GoUp is called twice with the second GoUp called without a Resume being invoked for the after the first GoUp, the resume information recorded to SV24 to SV27 is moved to the second resume information set at SV28 to SV31. If a Resume is then called the player executes the Resume using the Resume information stored to SV24 to SV27, and then restores the resume information in SV28 to SV31 to SV24 to SV27.

A script can also use the “Still” command to pause playback. The “Still” includes as an argument the number of seconds to pause playback as follows.

Still(10);

A script can also control user operations. For example, a script could prohibit functions such as fast-forward for a certain part of a title. This can be used to, for example, prevent the user from fast forwarding through content such as the copyright notice that the content provider does not want the user to skip.

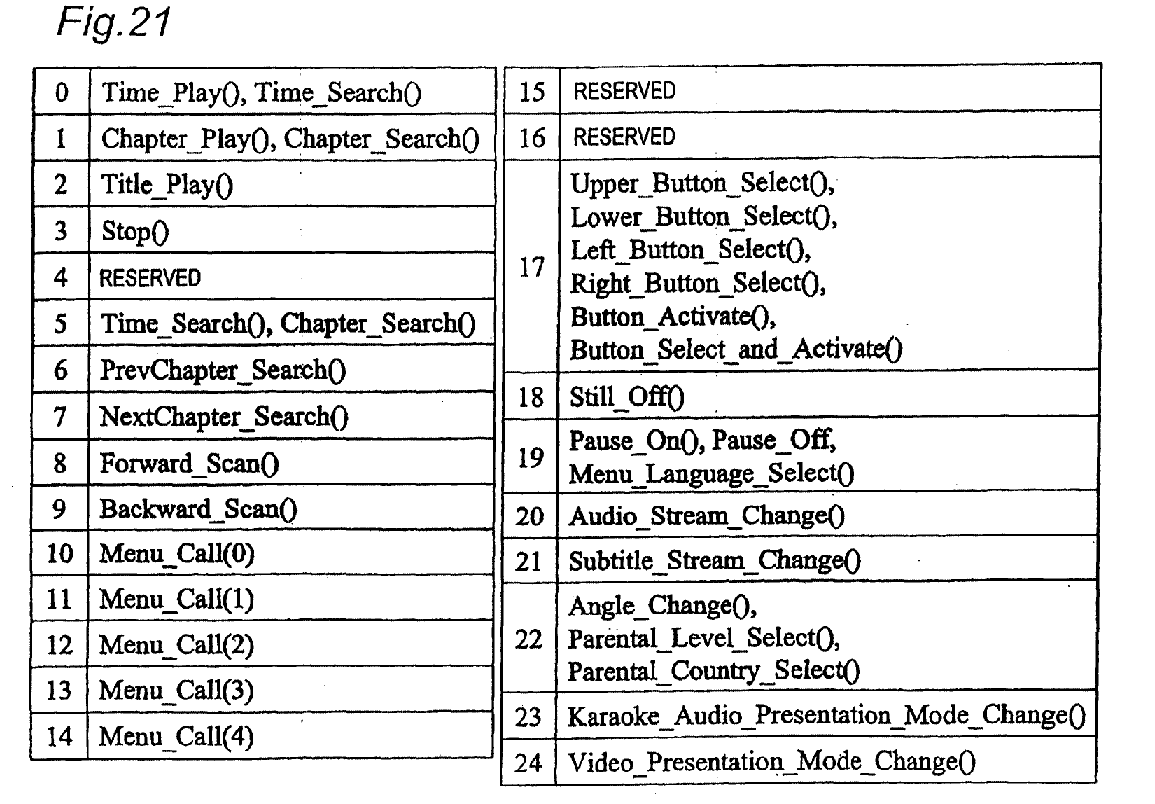

FIG. 21 is a table of available user operations.

Time_Play ( )

specifies the title, chapter, and time for

playback

Time_Search ( )

specifies the time within the same title for

playback

Chapter_Play ( )

specifies a chapter in the same title for

playback

Title_Play ( )

specifies the title for playback

Stop ( )

stops playback

PrevChapter_Search ( )

plays the chapter before the chapter currently

being played

NextChapter_Search ( )

plays the next chapter after the current chapter

being played

Forward_Scan( )

fast-forward play

Backward_Scan( )

fast-reverse play

Menu_Call (0)

calls the global event handler for the ″red″

button

Menu_Call (1)

calls the global event handler for the ″green″

button

Menu_Call (2)

calls the global event handler for the ″blue″

button

Menu_Call (3)

calls the global event handler for the ″orange″

button

Menu_Call (4)

calls the global event handler for the ″yellow″

button

Upper_Button_Select ( )

calls the event handler for the remote control up

key

Lower_Button_Select ( )

calls the event handler for the remote control

down key

Left_Button_Select ( )

calls the event handler for the remote control

left key

Right_Button_Select ( )

calls the event handler for the remote control

right key

Button_Activate ( )

calls the event handler for the remote control

select (activate) key

Button_and_Activate ( )

inputs the button number passed from the remote

control and calls the corresponding select key event
handler

Still_Off ( )

cancels the Still command from a script

Pause_On ( )

pauses playback

Pause_Off ( )

cancels the playback pause

Menu_Language_Select ( )

selects the menu display language

Audio_Stream_Change ( )

changes the audio stream

Subtitle_Stream_Change ( )

changes the subtitle stream

Angle_Change ( )

changes the view angle

Parental_Level_Select ( )

selects the parental control level

Parental_Country_Select ( )

selects the parental control level and country

(region) setting

Karaoke_Audio_Presentation_Mode_Change ( )

changes the karaoke audio mode

Video_Presentation_Mode_Change ( )

changes the video playback signal (wide, normal,

Pan-scan, letterbox)

The above user operations (UOP) can be enabled or disabled with the following functions. The “number” supplied as an argument corresponds to the numbers shown in the left columns in FIG. 21.

InvalidateUOP(number);

ValidateUOP(number);

Using the argument 0×ff can batch invalidate or validate all UOP.

InvalidateUOP(0×ff);

ValidateUOP(0×ff);

Other script functions include batch initialization of all 16 general variables using the script function Initialize( ):

Initialize(initialization number);

controlling the image displayed according to a highlighted button:

Highlight(button number);

and changing the audio stream and subtitle stream:

ChangeAudio(audio stream number);

ChangeSubtitle(subtitle stream number);

(Data structure)

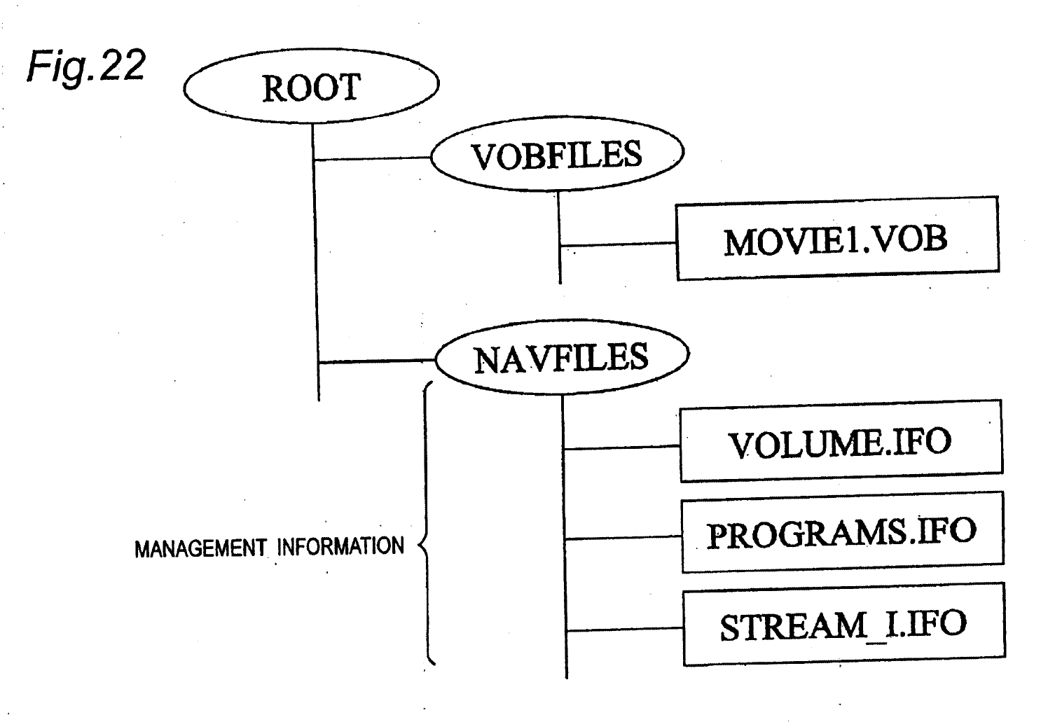

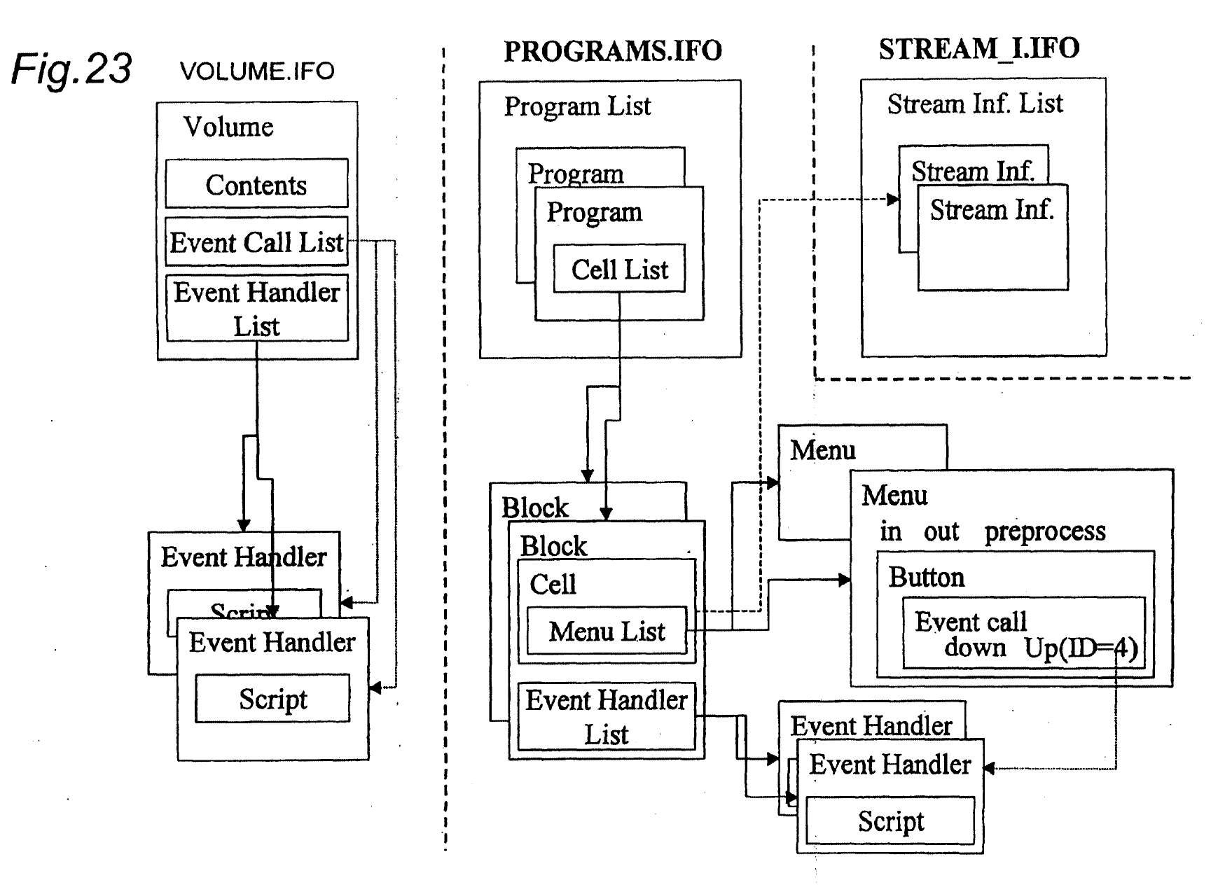

The file and data structure is described next using FIG. 22 and FIG. 23.

FIG. 22 shows the disc directory and file structure. As described above with reference to SD-DVD media, data on the disc can likewise be accessed through the file system on HD-DVD media.

Directly below the root directory “ROOT” are two special directories “VOBFILES” and “NAVFILES”. “VOBFILES” is a directory of files recording VOB data, and contains one or more VOB files. Each VOB is stored to a separate file, and the navigation data enables finding a desired VOB by specifying the file name.

“NAVFILES” is a directory of navigation data, and contains three special files: “VOLUME.IFO”, “PROGRAMS.IFO”, and “STREAM.IFO”.

The “VOLUME.IFO” file records volume information for managing the entire disc, “PROGRAMS.IFO” records information about the programs and cells on the disc, and “STREAM.IFO” records attributes of each VOB. These files are described in further detail below.

FIG. 23 shows the overall structure of the navigation data.

As noted above the navigation data includes Volume information, a Program List, and a Stream Information List.

The Volume contains the Contents, Event Call List, and Event Handler List. The Program List is a list of multiple programs with each program containing a Cell List. The Cell List is a list of one cell or multiple parallel cells (such as cells selectively played for a multiangle view) arranged in chronological order. The Cell List also stores the menus presented in a cell, and an Event Handler List of event handlers called from the cell or associated menus. The Stream Information List records the stream information for each VOB.

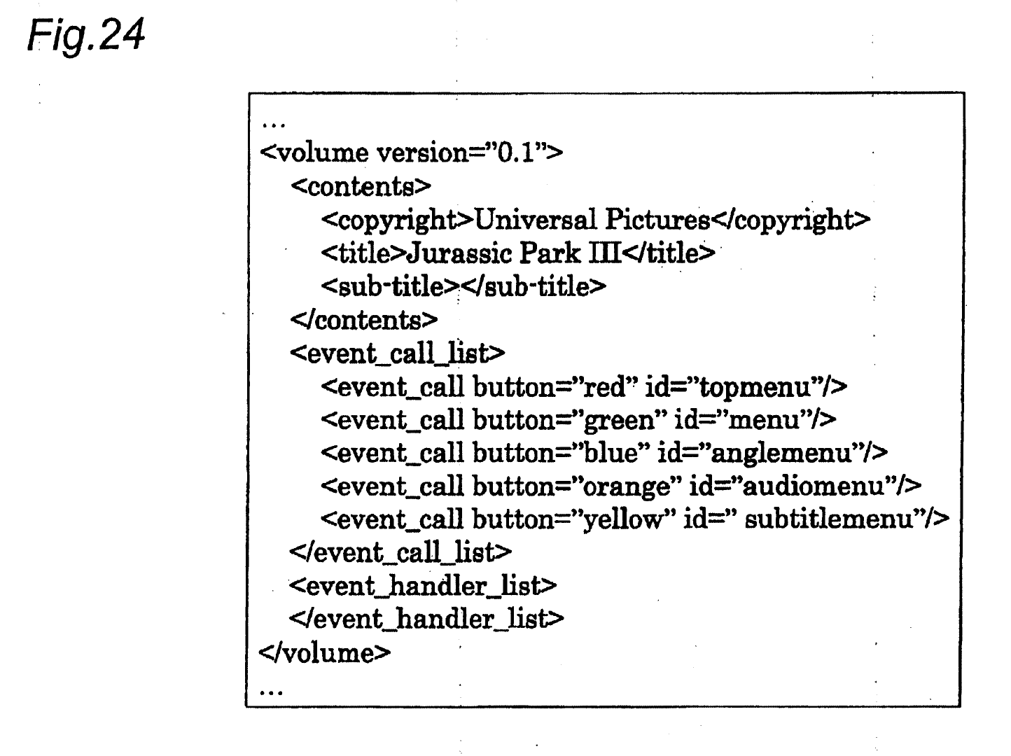

FIG. 24 shows the volume information (Volume) in detail. As will be known from FIG. 24 the navigation data is written in XML (eXtensible Markup Language).

The volume information is enclosed in <volume> tags and as noted above has <contents>, <event_call_list>, and <event_handler_list> child elements, and a version information (version).

The contents information (contents) has copyright information (copyright), name of title (title), and name of sub-title (sub-title) child elements.

As described with reference to FIG. 13, event call list (event_call_list) has declaration (event_call) child elements for calling the event handler corresponding to the five colored keys (buttons) on the remote control. The event handler declaration (event_call) has no child elements but has two attributes, i.e. information corresponding to colored keys (button) and ID corresponding to the event handler (id).

The event handler list (event_handler_list) has an event handler (event_handler) child element as described in further detail below.

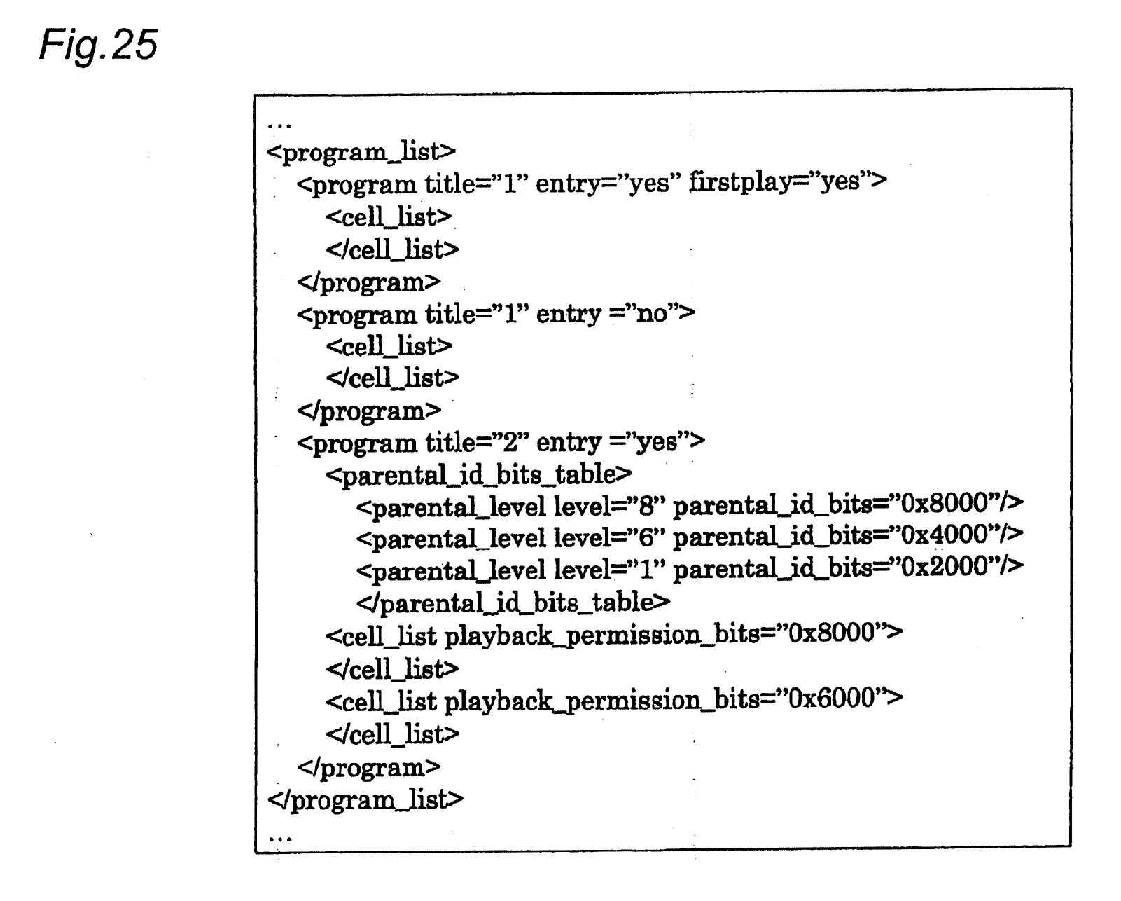

FIG. 25 describes program list information (Program List) in detail. As shown in the figure the program list information (program_list) has plurality of program child elements (Program). It has no attributes.

Each of program information (program) has a cell list (cell_list) and optional parental ID bits table (parental_id_bits_table) child elements. Attributes are the title number (title), entry information (entry), and first play information (first_play) information.

The title number (title) is the title number displayed on the front panel of the disc player or in the on-screen display of the television during playback of the program. If there are multiple programs in a title (i.e., multiple programs share the same title number), the entry information (entry) is used to identify the first program (program) in the title. This entry information is used primarily to get the first program in a title in response to a user operation such as a Title_Search( ). The first play information (first_play) identifies the program that starts automatically when a disc is loaded into the player.

The parental ID bits_table (parental_id_bits_table) has parental level information (parental_level) containing parental control information as a child element; it has no attributes. The parental level information (parental_level) has two attributes, i.e. level (level) and parental ID bits (parental_id_bits), that serve the function of the first table described with reference to FIG. 14.

The cell list (cell_list) element may have playback_permission_bits (playback_permission_bits) attribute. This playback_permission_bits attribute is always declared when the parental ID bits table (parental_id_bits_table) is present, and is always undeclared if the a rental ID bits table (parental_id_bits_table) is not present. The playback permission bits (playback_permission_bits) element serves the function of the second table described with reference to FIG. 14.

There is always at least one cell list (cell_list) in the program, but insofar as the parental ID bits table (parental_id_bits_table) is included there can be multiple selectively reproduced cell lists (cell_list).

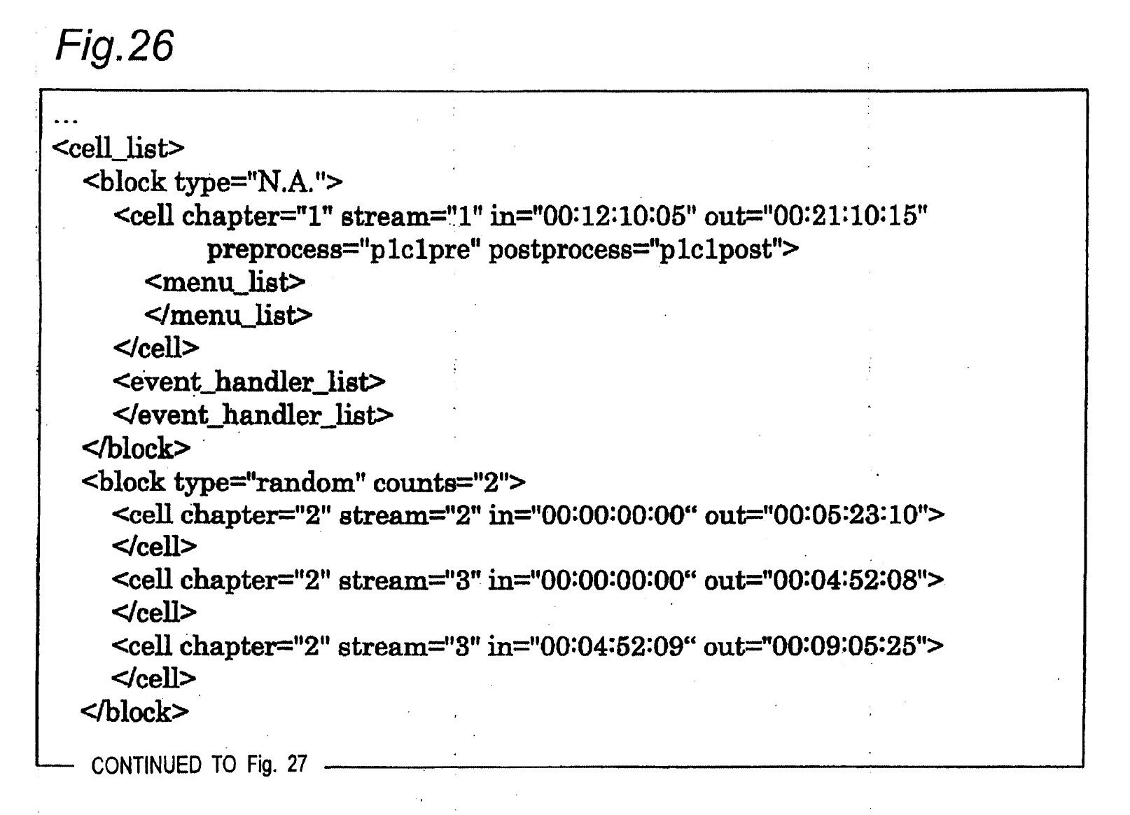

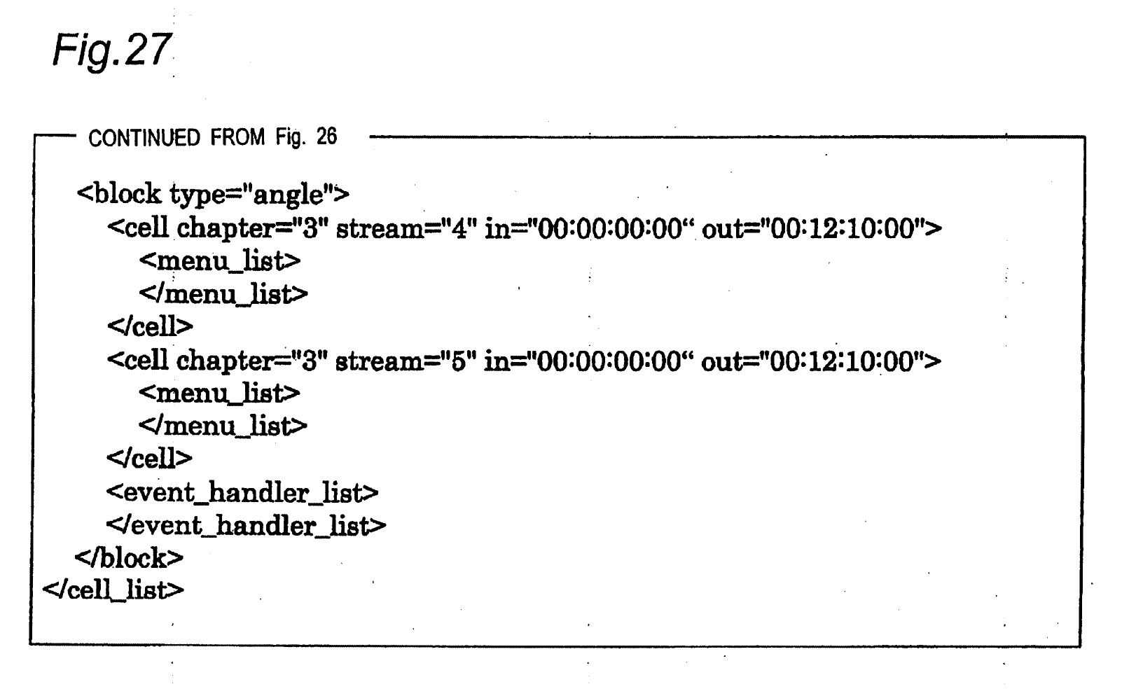

The content of the cell list <cell_list> is described in detail next with reference to FIG. 26 and FIG. 27. The cell list (cell_list) has one or more blocks (block) as child elements. The order of these blocks determines the playback sequence in the program. Each of the block has a type attribute, which takes one of the following values: “N.A.”, “random”, “shuffle”, or “angle”. These attribute values are described below.

N.A.: The block has one cell.

random: The block has multiple cells and the multiple cells are selected randomly for playback. Randomly selecting and playing cells repeats for the number of times determined by the contents attribute in the same block.

shuffle: The block has multiple cells and the multiple cells are shuffled for playback. Shuffled playback of the cells repeats for the number of times declared in the counts attribute of the block.

angle: The block has multiple cells, the multiple cells corresponding to different angles. The user can select a desired angle for playback. Playback can change to a different angle while playing one angle.

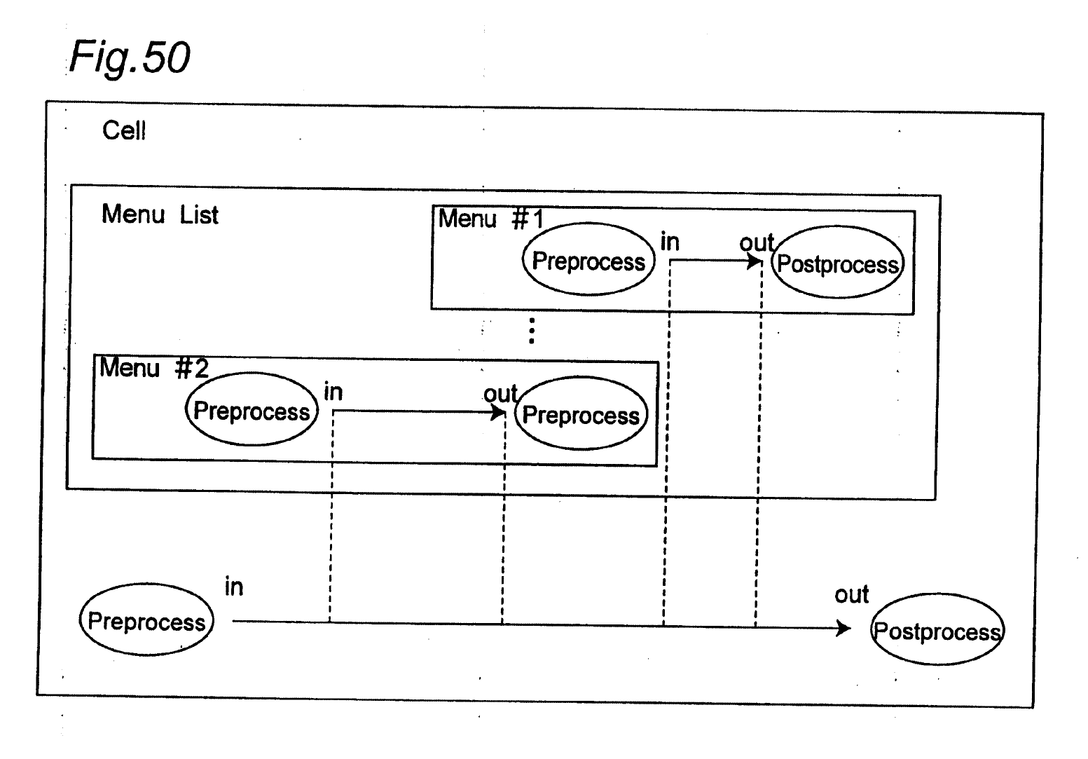

Each cell is declared with the <cell> tag. Referring also to FIG. 50, the cell can have a menu list (menu_list) as a child element and the following attributes: chapter number (chapter), referenced stream (stream), start time (in), end time (out), preprocess, and post-process.

Like the title number, the chapter number (chapter) is the number displayed on the front panel of the player or the on-screen display of the television while the corresponding cell is playing, and referenced stream (stream) is link information to stream information (stream_information). The start time (in) and end time (out) are the start and end times (relative times) in the VOB referenced by the cell.

The preprocess attribute is link information to an event handler, and declares the preprocess called by the cell as described with reference to FIG. 7 and FIG. 8. The post-process attribute is likewise link information to an event handler, and declares the post-process called by the cell as described with reference to FIG. 7 and FIG. 8.

The cell also has a menu list (menu_list) as a child element as described in further detail below.

Following the cell in the block is the event handler list <event_handler_list> as described in detail below.

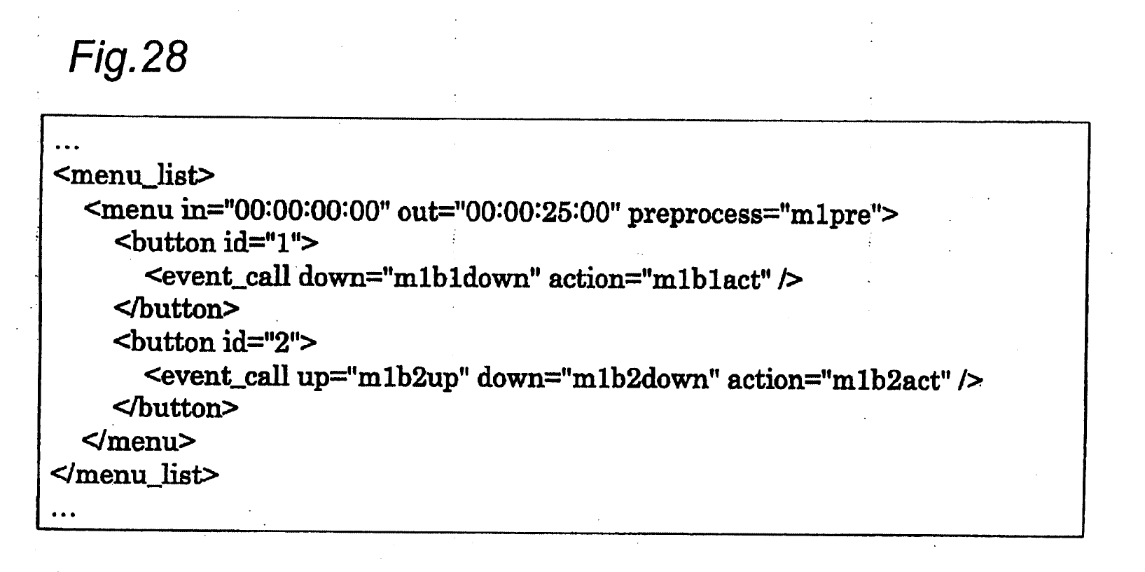

FIG. 28 describes the menu list (menu_list) tag in detail. The menu_list has multiple child elements. The menu has multiple buttons as child elements, and a playback start time (in), end time (out) and link information to the preprocess to run when the menu is activated. These attributes are as described above.

The button has an ID (id) attribute for identifying from other button. The button also has one event declaration (event_call) with the following attributes:

down: Link to the event handler called when the down cursor key (button) is pressed on the remote control.

up: Link to the event handler called when the up cursor key (button) is pressed on the remote control.

left: Link to the event handler called when the left cursor key (button) is pressed on the remote control.

right: Link to the event handler called when the right cursor key (button) is pressed on the remote control.

action: Link to the event handler called when the select key (button) is pressed on the remote control.

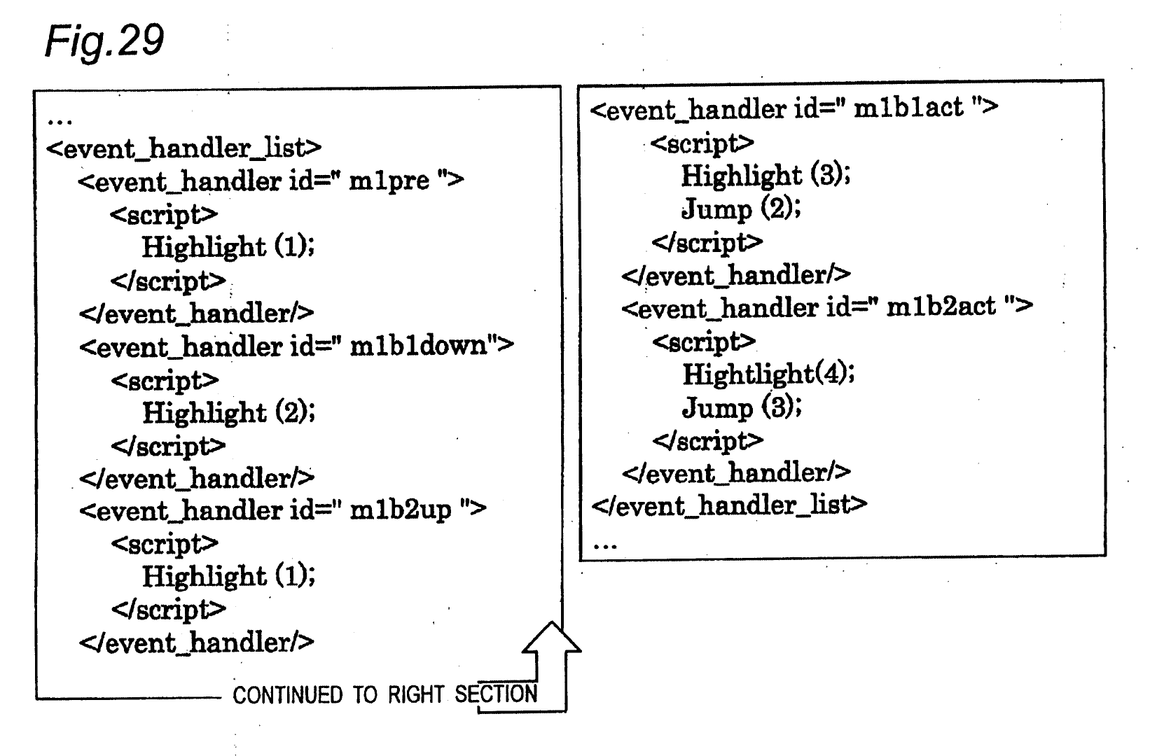

FIG. 29 describes the event handler list (event_handler_list) in detail.

The event handler list (event_handler_list) is located in the volume information (volume) or the block, and is closed within that data block.

This means that the event handler list (event_handler_list) in the volume information (volume) is referenced only by the event call list (event_call_list) in that volume information (volume), and the event handler list (event_handler_list) in the block is referenced only by cells or menus in that block.

The event handler list (event_handler_list) has one or more event handler (event_handler) as child elements. The event handler (event_handler) has a script as a child element. The script contains the script program. The event handler (event_handler) also has an ID “id” used by the event call declaration (event_call) to call an event handler.

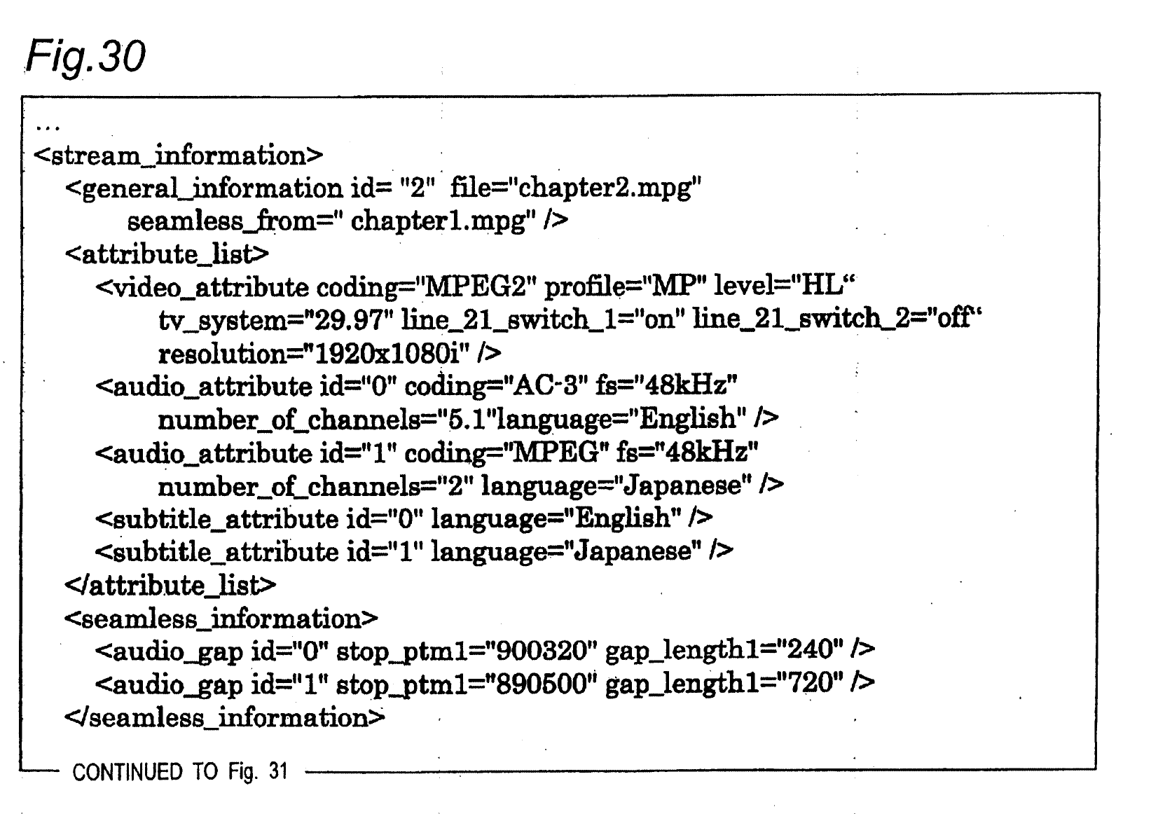

FIG. 30 describes the stream information (stream_information) that is a child element of the stream information table (stream_information_table).

The stream information table (stream_information) has general information (general_information), attribute information (attribute_information), seamless information (seamless_information), and time map (time_map) as child elements.

The general information (general_information) has no child elements, and has the following attributes: a general information identifier ID (id), file name (file), and seamless connection information (seamless_from). The ID (id) is a unique value identifying the general information in the stream information table, and is used to link from a cell. The file name (file) is the name of the stream file in the VOBFILES directory, and is used to reference a file. The seamless connection information (seamless_from) declares the VOB linked from to seamlessly connect the VOB with another VOB.

The attribute information (attribute_information) has no attributes but contains video attribute information (video_attribute_information), audio attribute information (audio_attribute_information), and subtitle attribute information (subtitle_attribute_information). The audio attribute information (audio_attribute_information) and subtitle attribute information (subtitle_attribute_information) contain attribute information for the number of respective streams in the VOB.

The video_attribute_information has as child elements the coding type, the profile and level if the coding type is MPEG-2, the frame rate, closed caption information 1 (line_{—}21_switch_{—}1), and closed caption information 2 (line_{—}21_switch_{—}2), and the resolution.

The audio attribute information (audio_attribute_information) has as child elements the stream ID (id), coding type, sampling frequency (sampling), number of audio channels (number_of_audio_channels), and language (language) as child elements. The subtitle attribute information (subtitle_attribute_information) has the stream ID (id) and language information (language) as a child element.

The seamless information (seamless_information) exists only when the seamless connection information (seamless_from) is used, and has audio gap information (audio_gap) as a child element relating to gaps in the audio portion of the stream. The audio gap information (audio_gap) tag has the following attributes: the stream ID (id) of the audio stream, audio gap start time (stop_ptm1/stop_ptm2) denoting the start time in the audio stream of an audio gap, i.e., interruption in the audio, and audio gap length (gap_length1/gap_length2) denoting the length of the audio gap.

An audio stream can have a maximum of two audio gaps, sequentially identified as audio gap 1 and audio gap 2. Accordingly, the audio gap start time (stop_ptm1/stop_ptm2) and the audio gap length (gap_length1/gap_length2) include corresponding two information as attributes.

The time map (time_map) has no attributes but has time information (stream_ptms) and a VOBU entry list (vobu_entry_list) as child elements. The time information, (stream_ptms) stores the VOB start time (in) and end time (out) as attributes. This time information is recorded using the 27 MHz clock specified in the MPEG standard, and is written as a time stamp in the stream.

The VOBU entry list (vobu_entry_list) records a VOBU entry (vobu_entry) as a child element for each VOBU in the VOB with the VOBU entry (vobu_entry) elements in the same order as the VOBU are recorded in the stream.

The VOBU entry (vobu_entry) has the following attributes: temporal length of the VOBU (duration), size, data size that must be read to reproduce the first I-picture in the VOBU (first), data size that must be read to reproduce the second reference picture, i.e. an I-picture or P-picture (second), and data size that must be read to reproduce the third reference picture, i.e. the I-picture or P-picture (third).

(Operation)

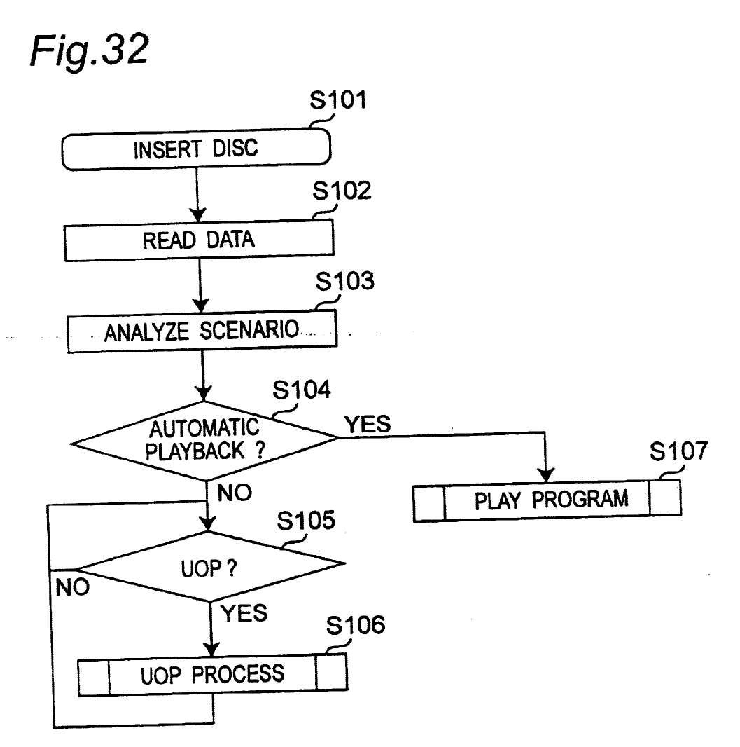

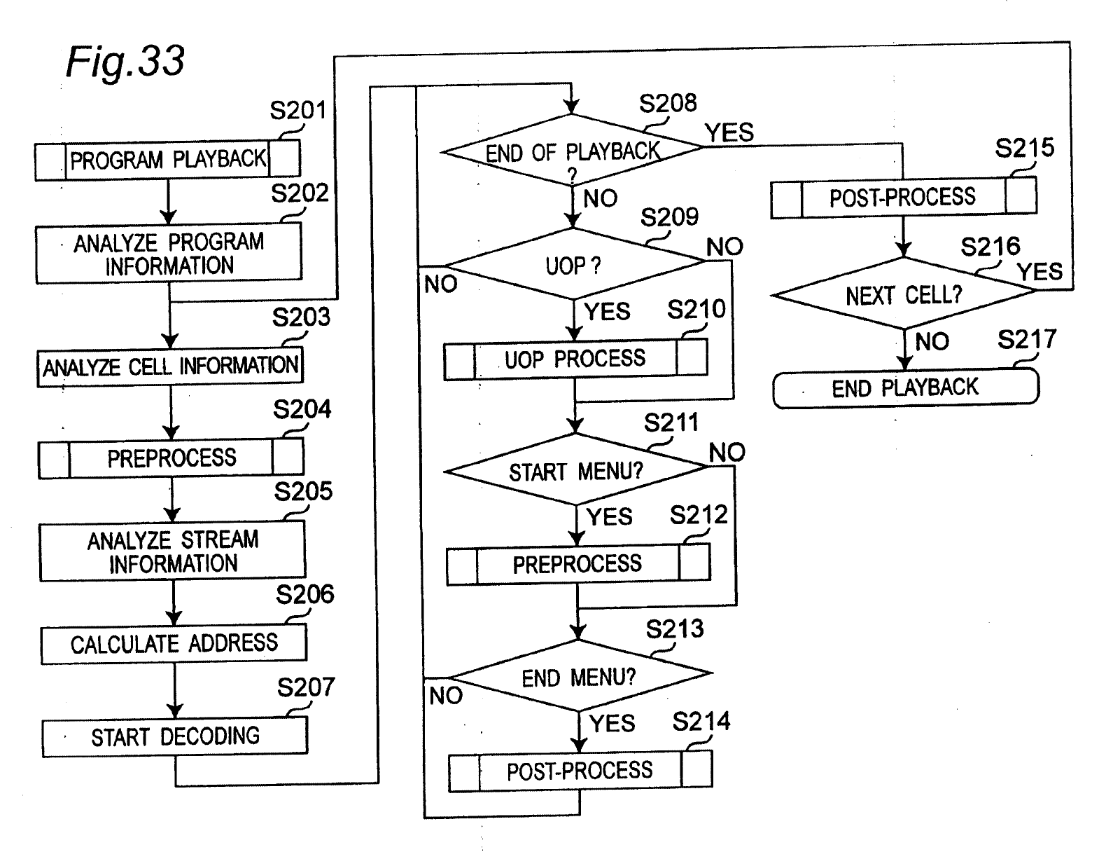

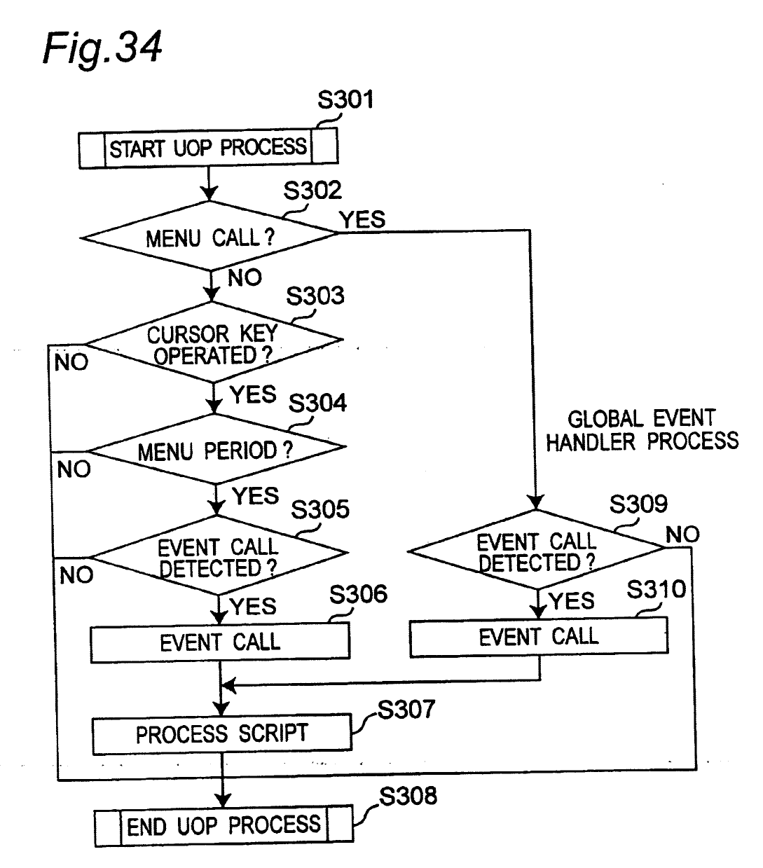

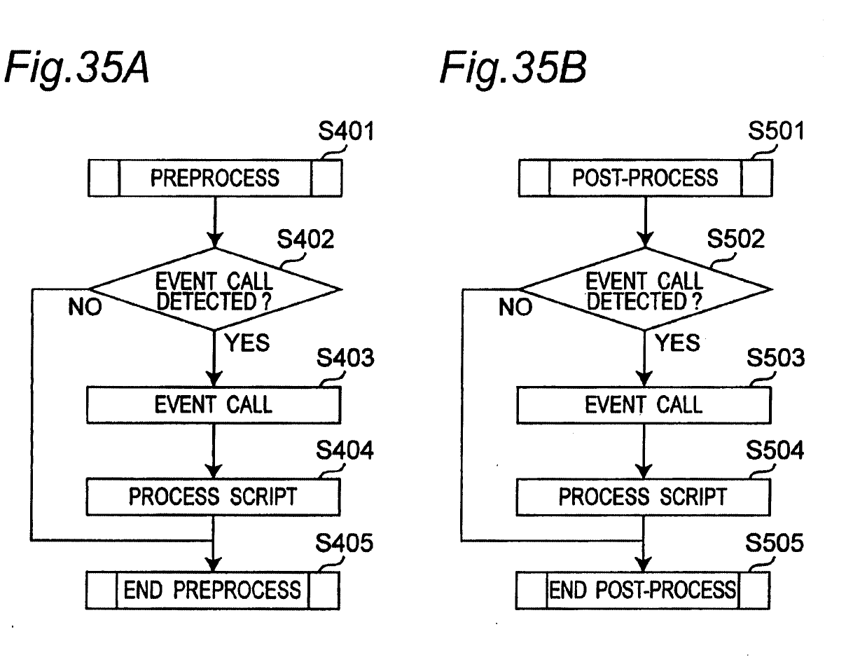

Operation of a disc player according to the present invention is described next with reference to FIG. 32, FIG. 33, FIG. 34, and FIG. 35.

FIG. 32 is a flow chart of the process from HD-DVD disc insertion to the start of playback.

When a new disc is inserted to the player (S101), the navigation file is read first and passed to the XML parser 201 (S102). The XML parser 201 analyzes the structure of the navigation data, passes the scenario information to the scenario processor 204, and the scenario processor 204 analyzes the scenario content (S103). The scenario processor 204 detects and processes the first play information (first_play) from the program information (S104). If the first play information (first_play) is found, playback of the program starts (S107). If the first play information is not detected, control goes to the UOP standby step (S105). User operations include, as described above, the user operating a key (button) on the remote control, invoking a menu, or navigating a menu (moving the highlighted object in a displayed menu). If a UOP is detected, the corresponding UOP process is called (S106).

FIG. 33 is a flow chart of the program playback step (S107) in FIG. 32. This flow chart is used when program playback is started by a script or other action.

When program playback starts (S201), the scenario processor 204 interprets the program information in detail (S202), then interprets the first cell information in the program (S203), and runs the cell preprocess (S204). The scenario processor 204 then interprets the stream information (S205), determines the address required for cell playback (S206), and starts stream decoding (S207).

Steps S208 to S214 repeat until cell playback ends. When cell playback ends (S208), the scenario processor 204 ends cell reproduction, and moves to the host process (S215). If cell playback has not ended, control goes to the UOP detection step (S209). If a UOP is detected (S209), the user operation is processed (S210), but whether a menu was called (begins) is otherwise determined (S211).

Processing user operations (S210) is described in detail below.

As described with reference to FIG. 6 and FIG. 28, a menu is a structure enabling dynamic scenarios. The player displays button images according to the menu structure, and the user can select and invoke the different buttons. If in the menu start detection (step S211) the menu has begun, that is, if the scenario processor 204 determines that the menu start time matches the internal clock, the scenario processor 204 runs the preprocess (S212).

The scenario processor 204 then determines if the menu has ended (S213). If it has, the scenario processor 204 runs the post-process (S214).

The preprocess (S212) and post-process (S214) steps are described further in detail below.

If in the cell play back judgement (step S208) cell playback has ended, playback moves to the next cell through the post-process (S215) of the script processor 202. Whether there is a next cell is first determined (S216). If there is not a next cell to reproduce, that is, if the cell for which playback just ended is the last cell in the program, playback ends (S217). If there is a next cell to reproduce, control returns to the cell information interpretation step (S203), and the next cell is then played.

FIG. 34 is a flow chart of the user operation handling process.

After starting the UOP process (S301), the scenario processor 204 first detects a UOP menu call (S302). If the UOP is a menu call, that is, if the user selects and operates one of the colored remote control keys (red, green, blue, orange, yellow), the script processor 202 runs the global event handler process. It first determines if there is an event call for the selected key (S309) and terminates the UOP process if there is not (S308). If there is the event call, the script processor 202 issues the event call (S310), and the script processor 202 processes the corresponding event handler script (S307) and then ends the UOP process (S308).

If the menu call detection step (S302) determines that the UOP is not a menu call, whether the UOP is a cursor key operation (up, down, right, left navigation keys) (S303). If the UOP is a cursor key operation, whether the current time is within the menu is determined (S304), and whether there is a corresponding event call is then determined (S305).

If steps S303, S304, and S305 all return yes, the scenario processor 204 issues an event call (S306), the script processor 202 processes the corresponding event handler script (S307), and the UOP process ends (S308).

If any of steps S303, S304, and S305 return no, the scenario processor 204 ends the UOP process (S308).

FIG. 35A is a preprocess flow chart and FIG. 35B is a post-process flow chart.

After the preprocess starts (S401), the scenario processor 204 determines if there is an event call for the preprocess (S402). If there is no event call, the scenario processor 204 ends the preprocess (S405). If there is an event call, the scenario processor 204 issues the event call (S403), the script processor 202 runs the script of the event handler invoked by the event call (S404), and the preprocess then ends (S405).

After the post-process starts (S501), the scenario processor 204 determines if there is an event call for the post-process (S502). If there is no event call, the scenario processor 204 ends the post-process (S505). If there is an event call, the scenario processor 204 issues the event call (S503), the script processor 202 runs the script of the event handler invoked by the event call (S504), and the post-process then ends (S505).

(Example of Menu)

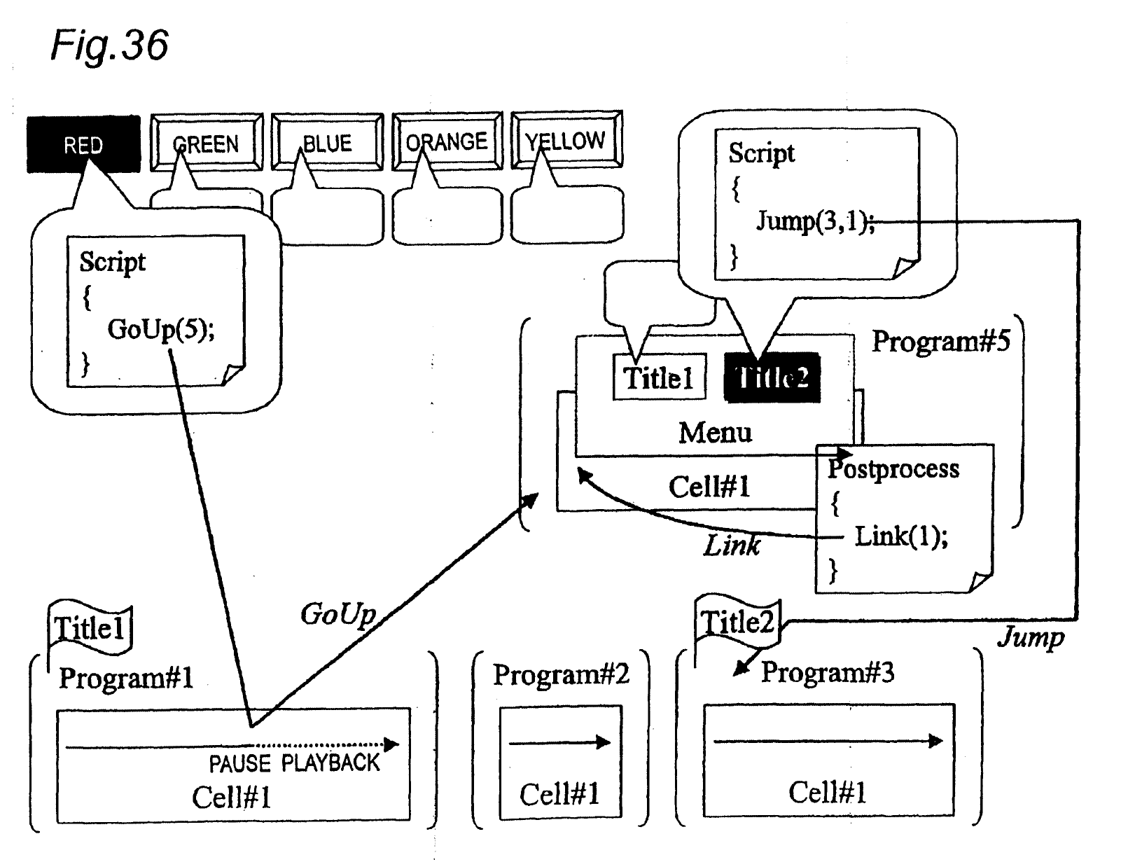

Menu processing using a global event handler is described next with reference to FIG. 36 to FIG. 40.

FIG. 36 is an example of a title selection menu. In this example the “red” key on the remote control corresponds to the title selection menu, i.e., invokes the title selection menu when pressed. As described above, this association is made by declaring the event handler identifier (id) in the <event_call> child element of the <event_call_list>, and setting the program corresponding to the title selection menu to play with the GoUp command in the event handler.

<volume>

<!-- script omitted -->

<event_call_list>

<event_call button=″red″ id=″ml″>

</event_call_list>
<event_handler_list>

<event_handler id=″ml″>

<script>

GoUp(5);

</script>

</event_handler>

</event_handler_list>

</volume>

When the user presses the red key on the remote control, the script is run through the corresponding global event handler. This sample script contains the instruction GoUp(5);

This causes the player to suspend playback of program #1, cell #1 that is currently being reproduced, and begin playback from program #5 as instructed by the GoUp(5) command. The player saves the location where playback was suspended, that is, program #1, cell #1, and the location (time) in cell #1 where playback stopped, to system variables SV24 to SV27.

<program>

<cell_list>

<block type=″N.A.″>

<cell stream=″1″

in=″00:00:00:00″
out=″00:00:30:00″>

<menu_list>

<menu

in=″00:00:00:00″
out=″00:00:30:00″
preprocess=″prel″
post-process=41 post141 >

<button id=″1″>

<Eevent_call

right=″b1r″
action=″b1a″>

</button>
<button id=″2″>

<Eevent_call

left=″b2l″
action=″b2a″>

</button>

</menu>

</menu list>

</cell>
<event_handler_list>

<event_handler id=″pre1″>

<script>

Highlight (0);

</script>

</event_handler>
<event_handler id=″post1″>

<script>

Link (1) ;

</script>

</event_handler>
<event_handler id=″b1r″>

<script>

Highlight (1);

</script>

</event_handler>
<event_handler id=″b1a″>

<script>

Highlight (2);
Jump (2, 1) ;

</script>

</event_handler>
<event_handler id=″b2l″>

<script>

Highlight (0);

</script>

</event_handler>
<event_handler id=″b2a″>

<script>

Highlight (3);
Jump (3, 1);

</script>

</event handler>

</event_handler list>

</block>

</cell_list>

</program>

A menu is displayed in program #5, cell #1, and buttons for selecting title #1 and title #2 are displayed on screen.

If playback of program #5, cell #1 ends without the user selecting a title for playback, the following cell #1 post-process runs.

Link(1);

This post-process causes playback of program #5, cell #1 to repeat. In other words, the cell continues to be reproduced until the user selects a title.

If the user selects title #2, the event handler for the button displaying “title #2” is called and the event handler script runs as follows.

Jump(3,1);

This script causes the player to begin playback of program #3 as title #2.

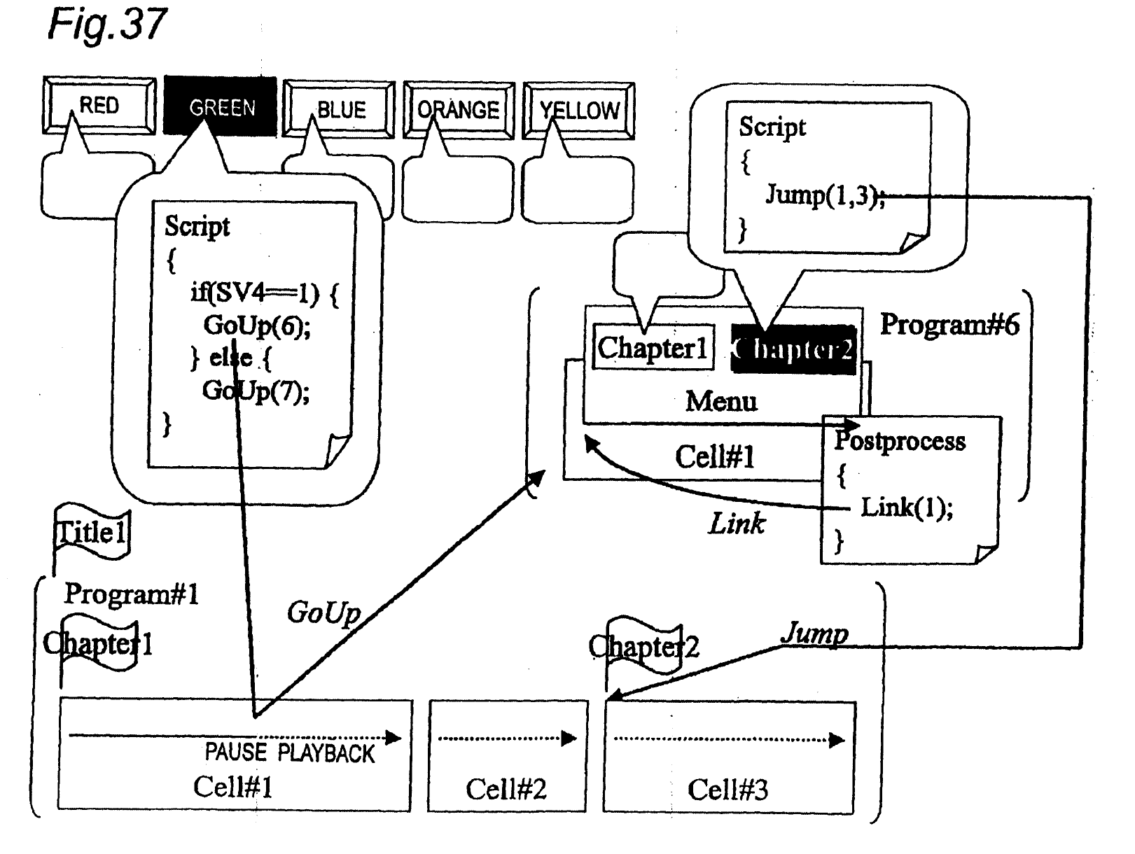

FIG. 37 shows an example of a chapter selection menu. In this example the “green” key on the remote control corresponds to the chapter selection menu, i.e., pressing the green key calls this menu.

When the user presses the green key on the remote control, the following script is run through the corresponding global event handler. The event handler script in this example is:

if(SV4==1)}

GoUp(6);

}else{

GoUp(7);

}

where SV4 is a system variable (SV) storing the number of the currently playing title. That is, the script content changes according to which title is playing. Because title #1 is playing in this example, the command GoUp(6) is executed.

This causes the player to suspend playback of program #1, cell #1 that is currently being reproduced, and begin playback from program #6 as instructed by the GoUp(6) command. The player saves the location where playback was suspended, that is, program #1, cell #1, and the location (time) in cell #1 where playback stopped, to system variables SV24 to SV27.

A menu is displayed in program #6, cell #1, and buttons for selecting chapter #1 and chapter #2 are displayed on screen.

If playback of program #6, cell #1 ends without the user selecting a chapter for playback, the following cell #1 post-process runs and playback of the same program and cell repeats.

Link(1);

If the user selects chapter #2, the event handler for the button displaying “chapter #2” is called and the event handler script runs as follows.

Jump(1,3);

This script causes the player to begin playback of program #1, cell #3 as chapter #2.

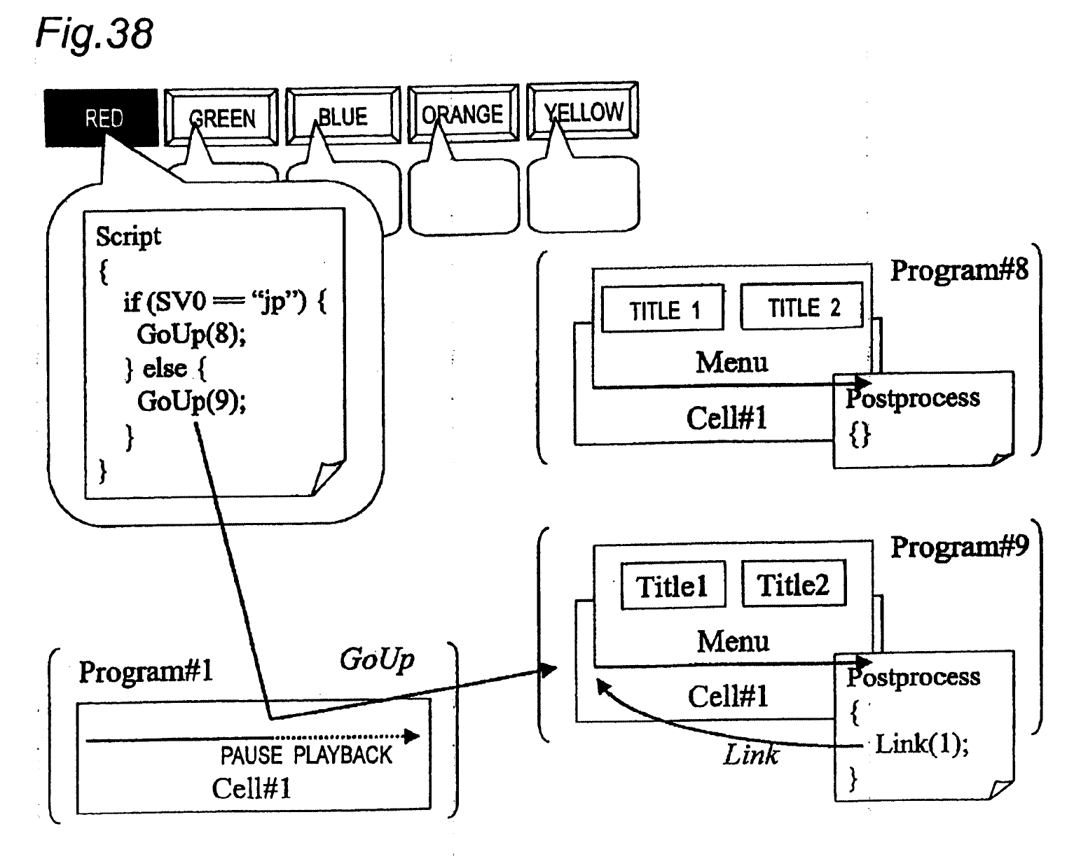

FIG. 38 shows an example of a multilingual title selection menu. In this example the red key on the remote control corresponds to the title selection menu, i.e., invokes the title selection menu when pressed.

When the user presses the red key on the remote control, the following script is run through the corresponding global event handler.

if(SV0==“jp”)}

GoUp(8);

}else{

GoUp(9);

}

where SV0 is a system variable storing the language setting (Language Code). In other words, the process changes according to the current language setting of the disc player. It is assumed below that the language setting of the disc player is set to English (en). It is further assumed that the branching condition of this process is whether the language is set to Japanese “jp”. Because the language is set to English “en” in this example, the GoUp(9) command is executed as described below.

This causes the player to suspend playback of program #1, cell #1 that is currently being reproduced, and begin playback from program #9 as instructed by the GoUp(9) command. The player saves the location where playback was suspended, that is, program #1, cell #1, and the location (time) in cell #1 where playback stopped, to system variables SV24 to SV27.

A menu is displayed in program #9, cell #1, and buttons for selecting title #1 and title #2 are displayed on screen in English. If the language was set to Japanese, the script executes GoUp(8) to reproduce program #8 containing Japanese language menus.

If playback of program #9, cell #1 ends without the user selecting a title for playback, the following cell #1 post-process runs and playback of the same program and cell repeats.

Link(1);

Subsequent operation is identical to the title selection menu described above with reference to FIG. 36.

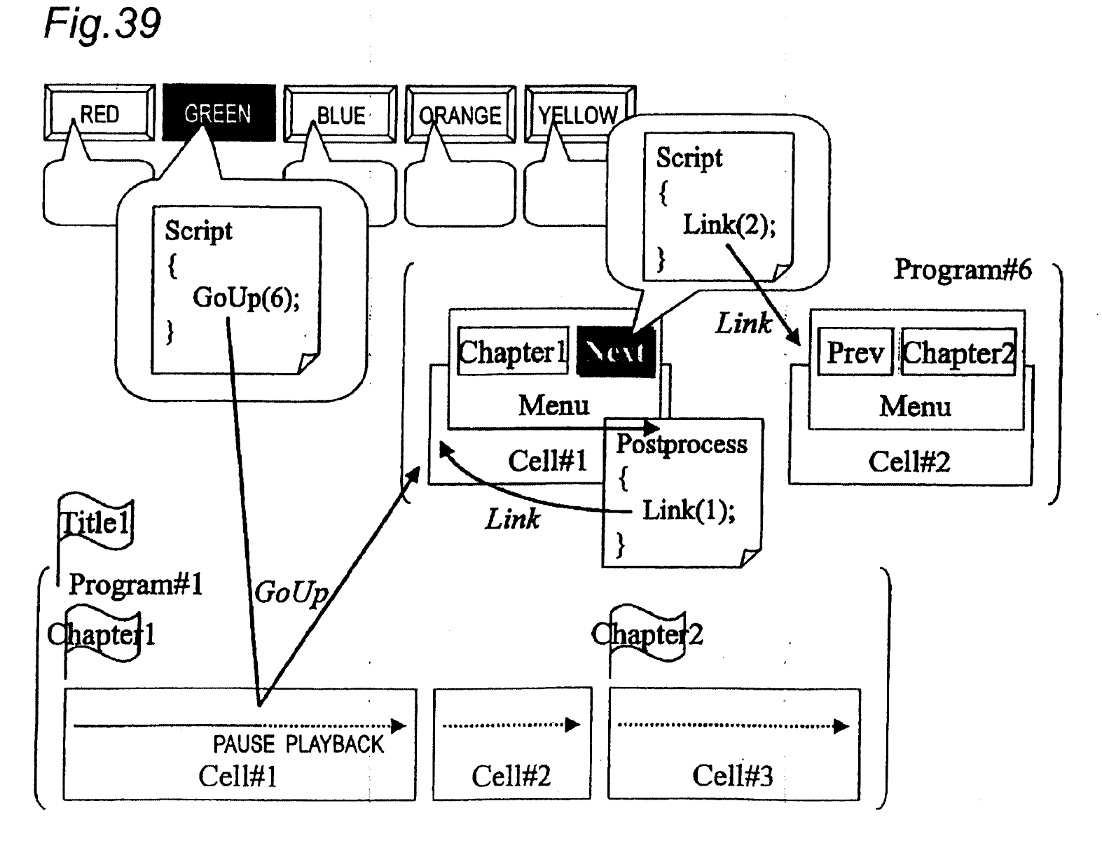

FIG. 39 is an example of a multipage chapter selection menu. In this example the “green” key on the remote control corresponds to the chapter selection menu, i.e., pressing the green key calls this menu.

When the user presses the “green” key on the remote control, the following script is run through the corresponding global event handler. The event handler script in this example is:

GoUp(6);

This causes the player to suspend playback of program #1, cell #1 that is currently being reproduced, and begin playback from program #6 as instructed by the GoUp(6) command. The player saves the location where playback was suspended, that is, program #1, cell #1, and the location (time) in cell #1 where playback stopped, to system variables SV(System Variable)24 to SV27.

A menu is displayed in program #6, cell #1, and buttons for selecting chapter #1 or selecting the next page (Next) are displayed on screen.

If playback of program #6, cell #1 ends without the user selecting a chapter for playback, the following cell #1 post-process runs and playback of the same program and cell repeats.

Link(1);

If the user selects the next page, the event handler corresponding to the button labelled “Next” is called and the event handler script shown below is run.

Link(2);

This script causes the player begin playback of cell #2 in the same program.

Each page of the menu is thus presented using a separate cell in the same program, and a multipage menu having multiple menus can thus be achieved.

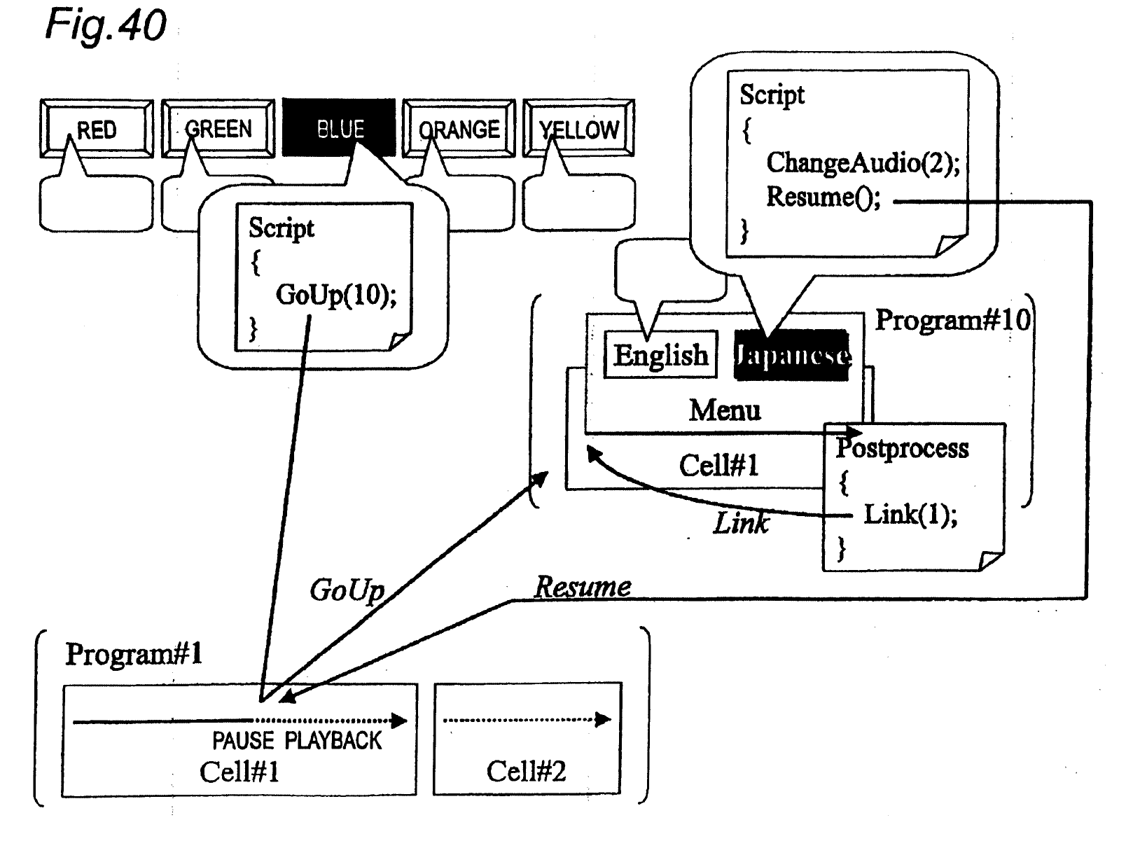

FIG. 40 shows an example of an audio selection menu. In this example the blue key on the remote control invokes the audio selection menu when pressed.

When the user presses the “blue” key on the remote control, the following script is run through the corresponding global event handler.

GoUp(10);

This causes the player to suspend playback of program #1, cell #1 that is currently being reproduced, and begin playback from program #10 as instructed by the GoUp(10) command. The player saves the location where playback was suspended, that is, program #1, cell #1, and the location (time) in cell #1 where playback stopped, to system variables SV(System Variable)24 to SV27.

An audio stream selection menu is presented by program #10, cell #1 with buttons for selecting English or Japanese also displayed.

If playback of program #10, cell #1 ends without the user selecting a title for playback, the following cell #1 post-process runs and playback of the same program and cell repeats until the user selects an audio track.

Link(1);

If the user has selected Japanese, the event handler for the button labelled “Japanese” is called and the event handler script is run as follows.

ChangeAudio(2);

Resume( );

This script causes the player to change the audio track to stream #2, and then calls the Resume( ) command. The Resume command causes playback to resume from the point in program #1, cell #1 where playback was previously suspended. The player does this by first reading the resume information stored to system variables SV24 to SV27.

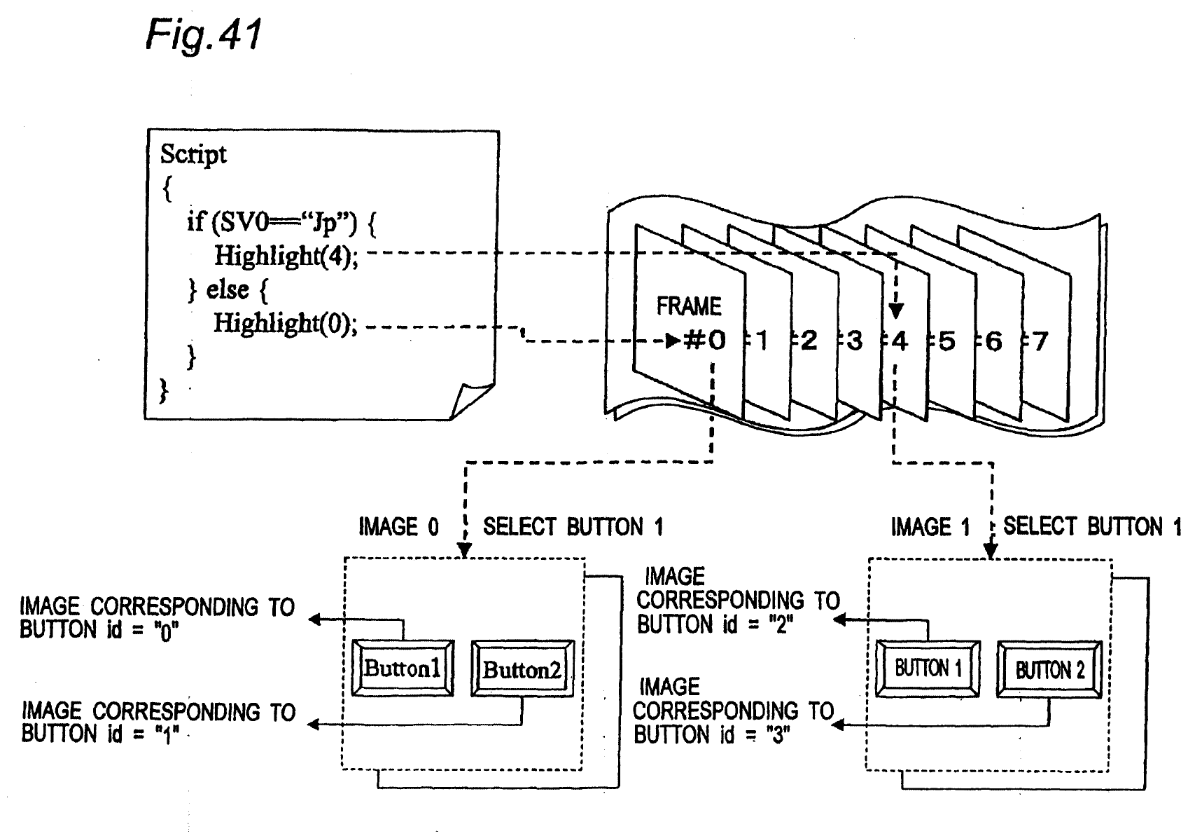

FIG. 41 shows an example of menus for multiple languages using image data. As described above, when a menu presentation period is entered the scenario processor 204 displays the menus based on the menu information. More specifically, the scenario processor 204 sends an event call corresponding to the preprocess of the menu information to the script processor 202.

The script processor 202 processes the event handler script. A sample script is shown in the upper left in FIG. 41.

Because conditional branching can be used in a script, the displayed images can be changed based on the language setting (SV0) as described in this example. In this example two image sets are prepared and multiplexed to the stream. One image set is for Japanese language menus, and the other is for English language menus.

Which language set is displayed first can also be controlled by the script. In this embodiment, such control is as follows.

if(SV0==“jp”){

Highlight (4);

}else{

Highlight (0);

}

If the language setting is Japanese the first display command Highlight(4) is executed, but if the language is set to English, the next display command Highlight(0) is executed, and images corresponding to the language setting are appropriately displayed.

The processes and display mode can be changed by assigning a different id to each button.

Conditional presentation of menus shall not be limited to providing multilingual support, and menus can be changed based on other conditions. For example, the playback history, such as the viewed story line, could be stored to general variables (GV) and the buttons changed according to the playback history.

(Links to external applications)

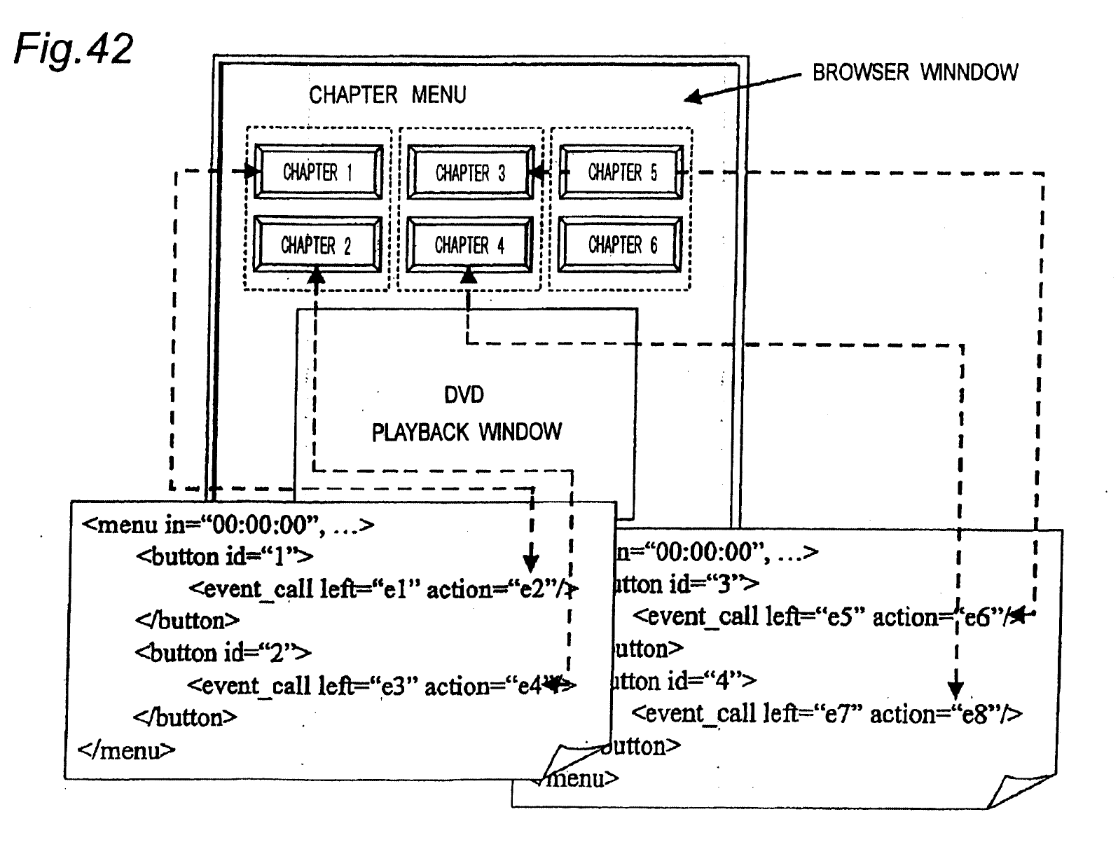

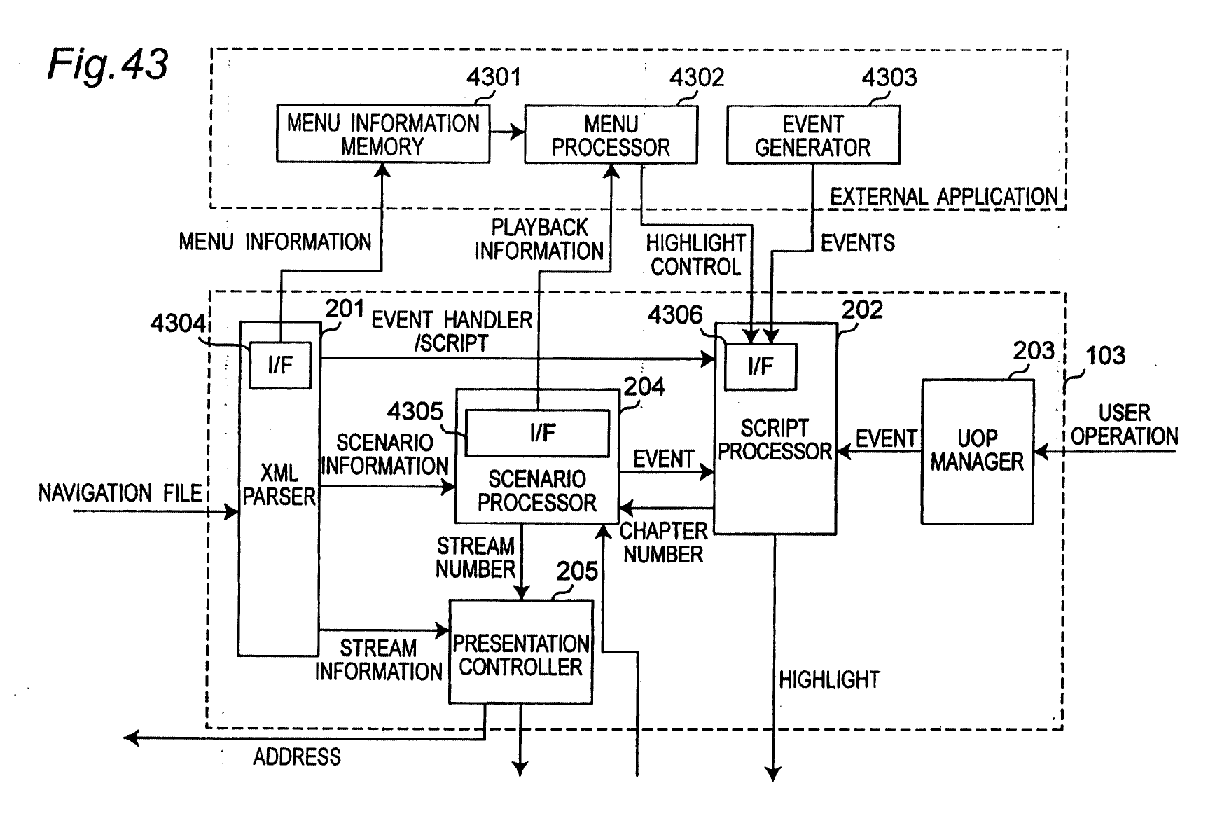

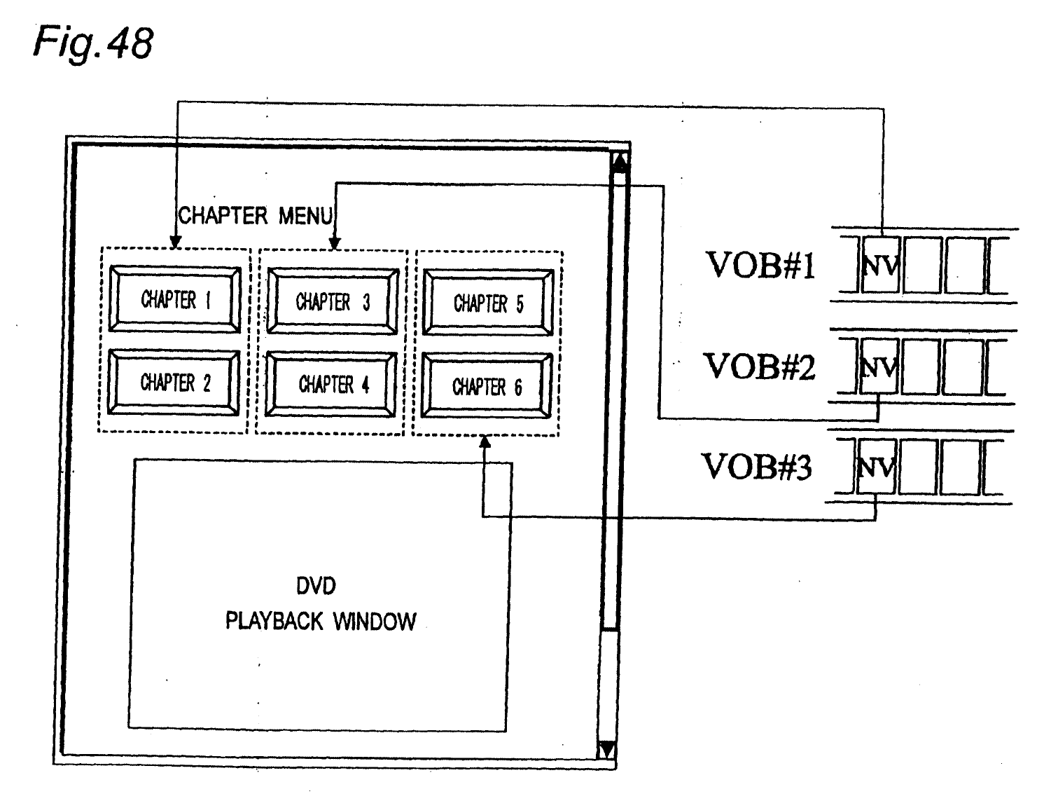

The connection to external applications is described next with reference to FIG. 42 and FIG. 43. Like FIG. 48, FIG. 42 shows the relationship to an external application. In this example a new application is achieved by merging the DVD video playback screen with text and other image data. As shown in the figure, a number of buttons for selecting chapters is displayed in a browser. While navigation data for these buttons is completely embedded in the stream with conventional SD-DVD media, all navigation data is written by the present invention to a non-stream area, thereby enabling the necessary information to be easily obtained. As shown in FIG. 42, the information needed to generate chapter menus can be extracted from multiple menu information listings, and displayed together in the same browser window.

The process for each button invokes and sends an event call contained in the menu information to the script processor of the disc player, thereby enabling processing by the player.

FIG. 43 is a block diagram showing the relationship between a HD-DVD player and an external application. The configuration of this HD-DVD player is as described above with reference to FIG. 2.

The XML parser (201) sends the interpreted menu information (<menu_list>) through an internal interface unit interface unit 4304 to the menu information memory (4301) of the external application. This menu information memory (4301) holds the menu information and passes it to the menu processor (4302) of the external application as needed. The scenario processor (204) passes the current playback status, such as the program being played, the cell and time information, through the interface unit (4305) to the menu processor (4302) of the external application in real time. The menu processor (4302) compares the playback information received in real time with the menu information, and if a menu presentation period is detected displays the corresponding buttons and other menu items in a browser or other application of its own.

If a user operates a button displayed in the browser by clicking on it, for example, the event generator (4303) of the external application sends an event call for that button to the script processor (202). Because the event handler of the button is received as menu information from the XML parser 201, the external application can issue appropriate event calls.

The menu processor (4302) can send a highlight control signal to the interface unit (4306) of the script processor (202). The highlight control signal is used by the script processor (202) to disable image presentation by the Highlight( ); function in the script program. After the script processor (202) receives the highlight control signal, it will not display images even if the Highlight( ); function is received. It is therefore possible to display the chapter selection button only on the application side shown in FIG. 42 and disable button display in the DVD playback window.

Furthermore, by including access control information for the external application in the menu information, access from the external application to individual menus and buttons can be controlled. This can be used, for example, to enable a button for branching (GoUp) to a bonus screen only on the HD-DVD itself, or to enable controls that are not executed on the DVD itself and only from the external application.

Control from the external application is achieved by passing events generated by the event generator (4303) through the interface unit (4306) of the script processor (202). These events are processed the same as events sent from the UOP manager (203) to the script processor (202). The script processor (202) runs an exclusive control process for the source of the event.

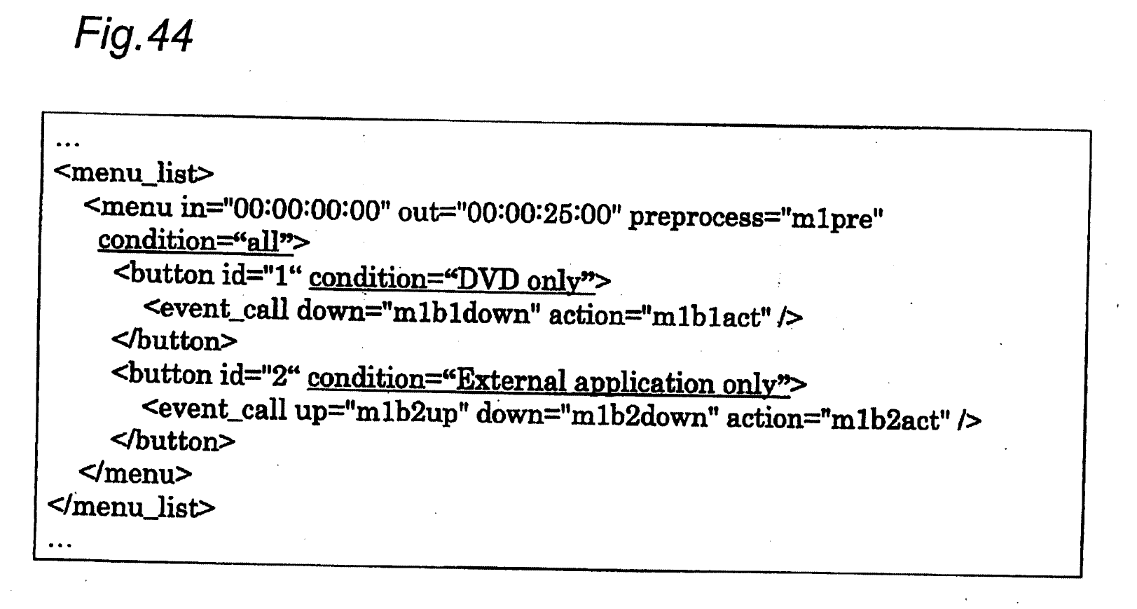

FIG. 44 shows an example of a menu listing. Both <menu> and <button> attributes have an access condition attribute “condition”. The interface unit (4304) of the XML parser (201) determines whether to provide the menu information and internal button information to the external application, and supplies the menu information and internal button information to the menu information memory (4301) of the external application accordingly.

Allowable values of the access condition attribute “condition” are “all” enabling access from the DVD and all external applications, “DVD only” enabling access only from the DVD, and “External application only” enabling access only from the external application.

The external application could also be segmented into plural levels with access conditions for each level contained in the menu information or button information. This makes it possible to conditionally control (enable/disable) access by different external applications.

As described above, new applications combining external applications with the HD-DVD player application can be easily achieved with the data structure and player configuration of the present invention.

The above preferred embodiment is described having five special keys i.e. “red”, “blue”, “green”, “yellow”, and “orange” on the remote control, but it will be obvious that the invention shall not be so limited. There could be more or less than five such keys, and the keys need not be color coded. Color is added to five specific keys in the present embodiment for convenience of description only.

Further, the files and directories for recording video data and navigation data are described as being at fixed locations and a fixed name, but the file and directory names and locations shall not be so limited.

Furthermore, the above second interface unit disables the highlight control signal from the script processor, but the second interface unit should be designed to stop the presentation controller from decoding or displaying video data so that absolutely nothing is displayed.

Furthermore, by using a system variable such as SV22 for linking display with an external application, the script program can determine whether playback is with the HD-DVD disc alone or synchronized with an external application such as an HTML document browser. This enables the displayed menus to be changed by the script program, i.e., two different programs can be written, one for playback using only the HD-DVD disc and one for playback linked with an external application, and the displayed menu can be changed according to the playback conditions.

Further, the external application is described as having menu information memory (4301), menu processor (4302), and event generator (4303), but the invention shall not be so limited as these are simply described as necessary function blocks. It will be obvious that a module having the same function, such as a single module combining the function of the menu processor 4302 and the event generator (4303), could also be used.

The navigation data (playback control information) is also described written as a text representation in XML, but the format and method of writing the data structure is not essential to the present invention and a binary data structure, for example, could be used. The XML parser could in this case function as a binary parser for reading and interpreting the navigation data and passing the necessary information to the required modules. Furthermore, the XML parser or binary parser need not be a discrete function block, and could be a module with the equivalent function, i.e., the scenario processor and script processor could have equivalent functionality.

Furthermore, in FIG. 43 the interface unit (4306) of the script processor (202) receives both highlight control from the menu processor (4302) and events from the event generator (4303), but separate interfaces could be provided for highlight control and events.

As will be obvious from the preceding description, the invention stores video objects separately from management information on package media, thereby enabling a variety of interactive scenarios without requiring seek processing to read the interactive scenario. The amount of video data and audio data in a video object is also not restricted.

Japanese patent application 2002-88472, which is a basis of the priority right of the present invention, is incorporated herein by reference.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A package medium for storing video objects and management information relating to the video objects for playback by a data reproduction apparatus,
wherein the management information includes playback list information and a plurality of event handlers activated by events including at least user operations, an identifier being assigned to each event handler, and
wherein the playback list information includes cell information containing information specifying a playback section of a video object and the identifier of the event handler valid while each playback section is being reproduced, and playback sequence information indicating the playback sequence of the playback sections specified by the cell information.

2. A package medium according to claim 1, wherein the cell information is allowed to indicate a part or all of the video object.

3. A package medium according to claim 1, wherein the playback list information includes a plurality of pieces of cell information, and
wherein each of two different pieces of cell information is allowed to specify a part or all of a same video object.

4. A package medium according to claim 1, wherein the management information includes an event handler that is enabled while the package medium is being reproduced by a reproduction apparatus.

5. A reproduction apparatus for reproducing a package medium storing video objects and management information relating to the video objects,
wherein the management information includes playback list information and a plurality of event handlers activated by events including at least user operations, an identifier being assigned to each event handler,
wherein the playback list information includes cell information containing information specifying a playback section of a video object and an identifier of an event handler valid when each playback section is being reproduced, and playback sequence information indicating the playback sequence of the playback sections specified by the cell information, and
wherein the reproduction apparatus includes:
a management information processing unit for extracting cell information and playback sequence information contained in the playback list information from the management information, receiving an event, and activating the event handler to which the corresponding identifier is assigned; and
a video object processing unit for reproducing the video object based on the cell information and playback sequence information extracted by the management information processing unit.

6. A reproduction apparatus according to claim 5, wherein the cell information is allowed to indicate a part or all of the video object.

7. A reproduction apparatus according to claim 5, wherein the playback list information includes a plurality of pieces of cell information, and
wherein each of two different pieces of cell information is allowed to specify a part or all of a same video object.

8. A reproduction apparatus according to claim 5, wherein the management information includes an event handler that is enabled while the package medium is being reproduced.

9. A reproduction method for reproducing a package medium storing video objects and management information relating to the video objects,
wherein the management information includes playback list information and a plurality of event handlers activated by events including at least user operations, an identifier being assigned to each event handler,
wherein the playback list information includes a plurality of pieces of cell information containing information specifying a playback section of a video object and an identifier of an event handler valid while each playback period is being reproduced, and playback sequence information indicating the playback sequence of the playback sections specified by the cell information, and
wherein the reproduction method comprises:
extracting cell information and playback sequence information contained in the playback list information from the management information;
reproducing a video object based on the cell information and playback sequence information; and
activating the event handler to which the identifier corresponding to the event is assigned at a detection of the event.

10. A reproduction method according to claim 9, wherein the cell information is allowed to indicate a part or all of the video object.

11. A reproduction method according to claim 9, wherein the playback list information includes a plurality of pieces of cell information, and
wherein each of two different pieces of cell information is allowed to specify a part or all of a same video object.

12. A reproduction method as described in claim 9, wherein management information includes an event handler that is enabled while the package medium is being reproduced.
